(19) United States
(12) Patent Application Publication
(10) Pub. No.: US 2026/0089632 A1
(43) Pub. Date: Mar. 26, 2026

(54) PDCCH MONITORING TRIGGERED BY A WAKE UP SIGNAL

(71) Applicant: Samsung Electronics Co., Ltd., Suwon-si (KR)

(72) Inventors: Hongbo Si, Allen, TX (US); Kyeongin Jeong, Frisco, TX (US); Anil Agiwal, McKinney, TX (US)

(21) Appl. No.: 19/321,110

(22) Filed: Sep. 5, 2025

Related U.S. Application Data
(60) Provisional application No. 63/699,535, filed on Sep. 26, 2024.
(60) Provisional application No. 63/702,984, filed on Oct. 3, 2024.
(60) Provisional application No. 63/704,827, filed on Oct. 8, 2024.
(60) Provisional application No. 63/705,146, filed on Oct. 9, 2024.
(60) Provisional application No. 63/718,234, filed on Nov. 8, 2024.
(60) Provisional application No. 63/722,269, filed on Nov. 19, 2024.
(60) Provisional application No. 63/773,774, filed on Mar. 18, 2025.
(60) Provisional application No. 63/800,829, filed on May 6, 2025.

(51) Int. Cl. H04W 52/02; H04B 7/06; H04W 72/231; H04W 72/51; H04W 76/28

(52) U.S. Cl. CPC H04W 52/0229; H04B 7/06968; H04W 72/231; H04W 72/51; H04W 76/28

(57) ABSTRACT

Methods and apparatuses for physical downlink control channel (PDCCH) monitoring triggered by a wake up signal (WUS). A method of a user equipment (UE) in a wireless communication system including receiving a set of higher layer parameters, determining, based on the set of higher layer parameters, a periodicity, a first time offset, a timer, and a number of WUS monitoring occasions (MOs), and determining a time domain window for monitoring the WUS that periodically occurs with the periodicity and includes the number of WUS MOs. The method further includes receiving a WUS based on the number of WUS MOs, determining a time instance to start the timer based on the first time offset, and determining to monitor a physical downlink control channel (PDCCH) when the timer is running.

### CROSS-REFERENCE TO RELATED AND CLAIM OF PRIORITY

The present application claims priority under 35 U.S.C. § 119 (e) to U.S. Provisional Patent Application No. 63/699,535 filed on Sep. 26, 2024; U.S. Provisional Patent Application No. 63/702,984 filed on Oct. 3, 2024; U.S. Provisional Patent Application No. 63/704,827 filed on Oct. 8, 2024; U.S. Provisional Patent Application No. 63/705,146 filed on Oct. 9, 2024; U.S. Provisional Patent Application No. 63/718,234 filed on Nov. 8, 2024; U.S. Provisional Patent Application No. 63/722,269 filed on Nov. 19, 2024; U.S. Provisional Patent Application No. 63/773,774 filed on Mar. 18, 2025; and U.S. Provisional Patent Application No. 63/800,829 filed on May 6, 2025, which are hereby incorporated by reference in their entirety.

### TECHNICAL FIELD

The present disclosure relates generally to wireless communication systems and, more specifically, the present disclosure relates to methods and apparatuses for physical downlink control channel (PDCCH) monitoring triggered by a wake up signal (WUS).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to PDCCH monitoring triggered by WUS.

In one embodiment, a base station (BS) in a wireless communication system is provided. The BS includes a processor configured to determine, based on a set of higher layer parameters, a periodicity, a first time offset, a timer, and a number of WUS monitoring occasions (MOs) and determine a time domain window to transmit a WUS, wherein the time domain window periodically occurs with the periodicity and includes the number of WUS MOs. The BS further includes a transceiver operably coupled to the processor. The transceiver configured to transmit the set of higher layer parameters and transmit the WUS based on the number of WUS MOs. The processor is further configured to determine a time instance to start the timer based on the first time offset and determine to transmit a PDCCH when the timer is running.

In another embodiment, a user equipment (UE) in a wireless communication system is provided. The UE includes a transceiver configured to receive a set of higher layer parameters and a processor operably coupled to the transceiver. The processor is configured to determine, based on the set of higher layer parameters, a periodicity, a first time offset, a timer, and a number of WUS MOs and determine a time domain window for monitoring the WUS. The time domain window periodically occurs with the periodicity and includes the number of WUS MOs. The transceiver is further configured to receive a WUS based on the number of WUS MO. The processor is further configured to determine a time instance to start the timer based on the first time offset and determine to monitor a PDCCH when the timer is running.

In yet another embodiment, a method of a UE in a wireless communication system is provided. The method includes receiving a set of higher layer parameters, determining, based on the set of higher layer parameters, a periodicity, a first time offset, a timer, and a number of WUS MOs, and determining a time domain window for monitoring the WUS that periodically occurs with the periodicity and includes the number of WUS MOs. The method further includes receiving a WUS based on the number of WUS MOs, determining a time instance to start the timer based on the first time offset, and determining to monitor a PDCCH when the timer is running.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates timelines for starting an example timer for PDCCH monitoring according to embodiments of the present disclosure;

FIG. 6 illustrates timelines for starting an example timer for PDCCH monitoring according to embodiments of the present disclosure;

FIG. 7 illustrates timelines for starting an example timer for PDCCH monitoring according to embodiments of the present disclosure;

FIG. 8 illustrates timelines for starting an example timer for PDCCH monitoring according to embodiments of the present disclosure;

FIG. 9 illustrates a timeline for starting an example timer for PDCCH monitoring according to embodiments of the present disclosure;

FIG. 10 illustrates a timeline for starting an example timer for PDCCH monitoring according to embodiments of the present disclosure;

FIG. 11 illustrates an example timer/time window determination according to embodiments of the present disclosure;

FIG. 12 illustrates an example UE procedure for PDCCH monitoring triggered by a low power (LP)-WUS according to embodiments of the present disclosure;

FIG. 13 illustrates a timeline of an example application time delay indicated by a downlink control information (DCI) format according to embodiments of the present disclosure;

FIG. 14 illustrates a timeline of an example time domain window for MOs of LP-WUS according to embodiments of the present disclosure;

FIG. 15A illustrates a timeline of an example time domain window for MOs of LP-WUS according to embodiments of the present disclosure;

FIG. 15B illustrates a timeline of example LP-WUS monitoring according to embodiments of the present disclosure;

FIGS. 16A and 16B illustrate timelines of an example duration for PDCCH monitoring according to embodiments of the present disclosure;

FIGS. 17A and 17B illustrate timelines of an example duration for PDCCH monitoring according to embodiments of the present disclosure;

FIG. 18 illustrates a timeline of example LP-WUS monitoring according to embodiments of the present disclosure;

FIG. 19 illustrates a flowchart of an example UE procedure for LP-WUS monitoring according to embodiments of the present disclosure;

FIG. 20 illustrates a timeline of example LP-WUS monitoring according to embodiments of the present disclosure;

FIG. 21 illustrates a flowchart of an example UE procedure for LP-WUS monitoring according to embodiments of the present disclosure;

FIG. 22 illustrates a timeline for terminating an example timer for PDCCH monitoring according to embodiments of the present disclosure; and

FIG. 23 illustrates a timeline for LP-WUS monitoring according to embodiments of the present disclosure.

### DETAILED DESCRIPTION

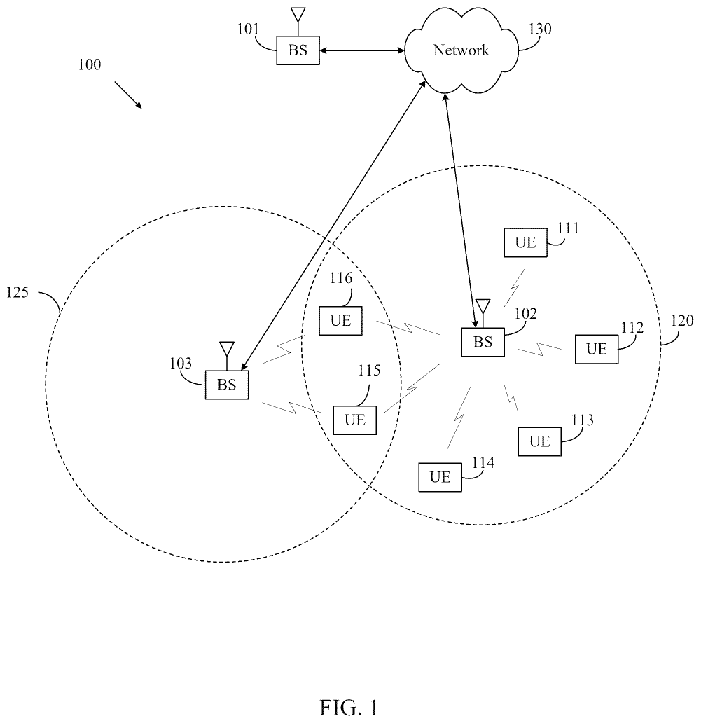

FIGS. 1-23, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v17.1.0, “NR; Physical channels and modulation;” [REF 2] 3GPP TS 38.212 v17.1.0, “NR; Multiplexing and channel coding;” [REF 3] 3GPP TS 38.213 v17.1.0, “NR; Physical layer procedures for control;” [REF 4] 3GPP TS 38.214 v17.1.0, “NR; Physical layer procedures for data;” and [REF 5] 3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing PDCCH monitoring triggered by a WUS. In certain embodiments, one or more of the gNBs 101-103 include circuitry, programing, or a combination thereof to support PDCCH monitoring triggered by a WUS.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

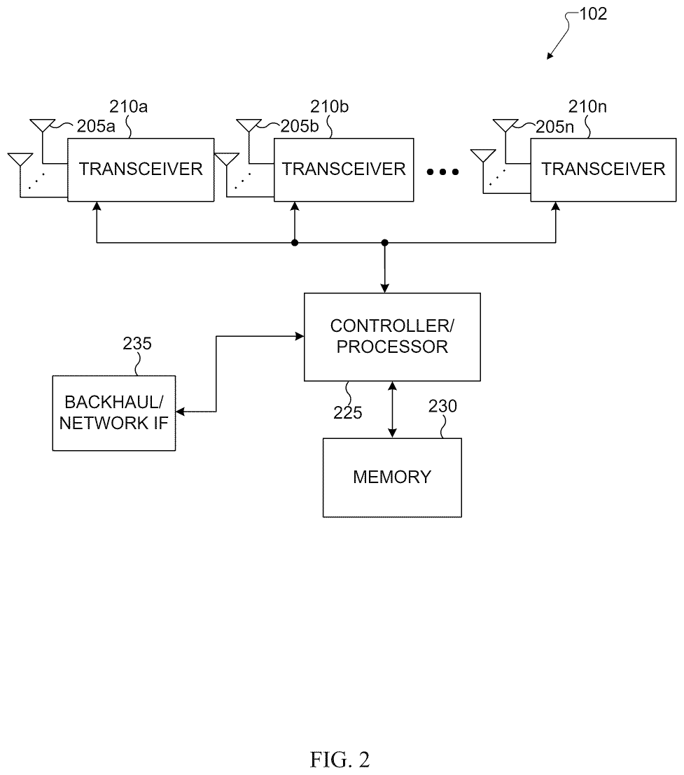

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting PDCCH monitoring triggered a WUS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

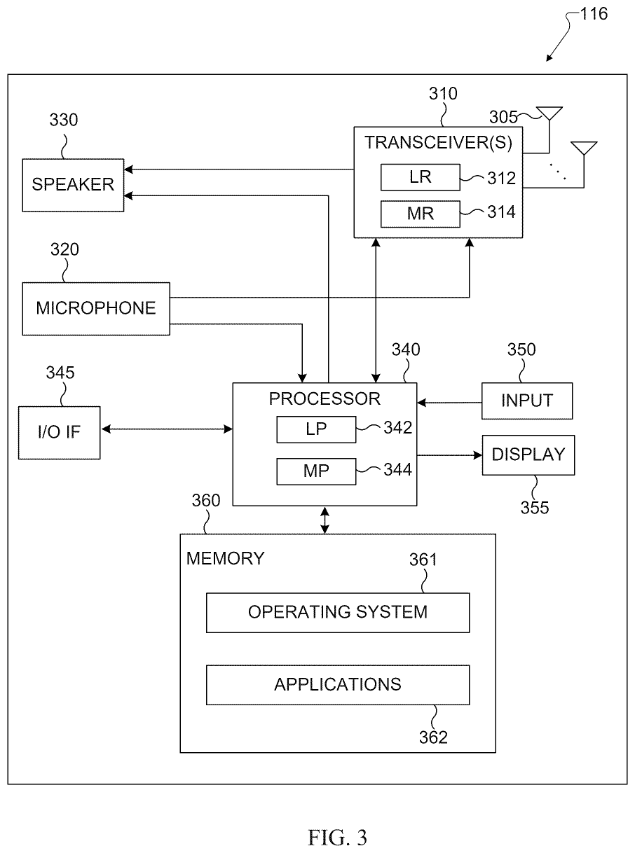

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify PDCCH monitoring triggered by a WUS as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

In various embodiments, the transceiver(s) 310 include or are at least one LR 312 and at least one MR 314. For example, as discussed in greater detail below, the LR 312 may be configured or utilized to receive low power signals (e.g., a LP-WUS), for example, when the UE 116 is in a sleep state (e.g., such as an ultra-deep sleep state), while the MR 314 is powered off or in a low power state. For example, in some embodiments, the LR 312 may be a component of the transceiver(s) 310 used or powered on when the UE 116 is in the sleep state while the MR 314 is the transceiver(s) 310 and used when the UE 116 is not in the sleep state. In another example, in other embodiments, the LR 312 may be receiver that is separate or discrete from the transceivers(s) 310 which is the MR 314 used for ordinary reception operations when the UE 116 is not in the sleep state.

Analogously, in such embodiments, the processor 340 includes or is at least one of the low-power processor (LP) 342 and the main processor (MP) 344. For example, in some embodiments, the LR 312 and the MR 314 may be connected to and/or be controlled by the LP 342 and the MP 344, respectively, which are separate and/or discrete processors. In these embodiments, the LP 342 may operate at a lower power state than the MP 344 such that, when the UE is in the sleep state, the MP 344 may be powered off or in a low power state while the LP 342 can process any signals (e.g., such as a LP-WUS) received by the LR 312. In these embodiments, the operation of the LP 342 may consume less power than ordinary operations of the MP 344 would, thereby saving power of the UE 116 in the sleep state while maintaining the ability of the UE 116 to receive and process signals. In other embodiments, the LP 342 and the MP 344 may be components of the processor 340 where the LR 312 and the MR 314 may be connected to and/or be controlled by the LP 342 and the MP 344, respectively. In these embodiments, when the UE 116 is in the sleep state, MP 344 components of the processor 340 are powered off or in a low power state and LP 342 components operate to process signals (e.g., such as a LP-WUS) received by the LR 312. In these embodiments, the operation of the LP 342 components of the processor 340 may consume less power than ordinary operations of the processor 340 including the operations of the MP 344 components would, thereby saving power of the UE 116 in the sleep state while maintaining the ability of the UE 116 to receive and process signals.

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

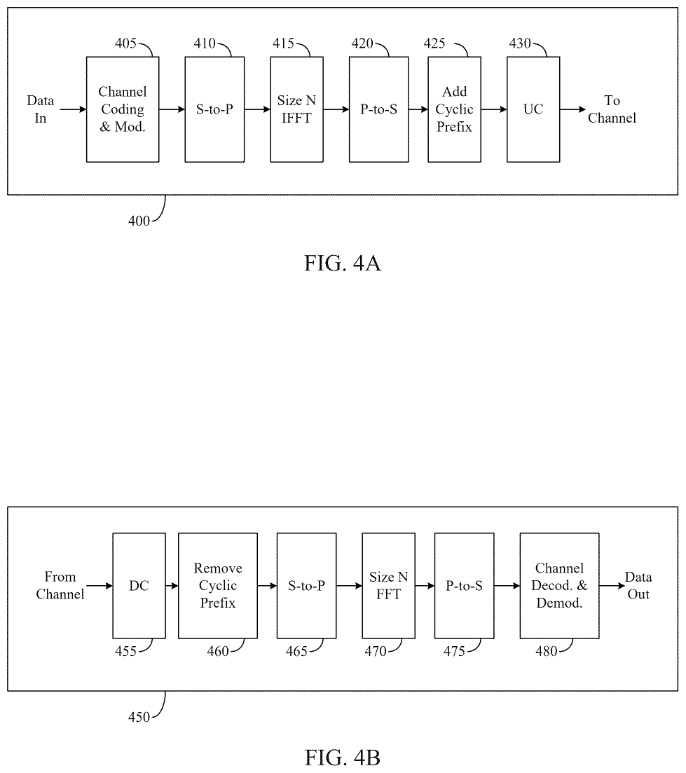

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured to perform actions for PDCCH monitoring triggered a WUS as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

NR supported discontinuous reception (DRX) for a UE in either RRC_IDLE/RRC_INACTIVE mode or RRC_CONNECTED mode, such that the UE could stop receiving signals or channels during the inactive period within the DRX cycle and save power consumption. In Rel-16, enhancement towards DRX for RRC_CONNECTED mode (e.g., C-DRX) was introduced, wherein a new DCI format was used to help the UE to skip a ON duration within a C-DRX cycle such that further power saving gain could be achieved. In Rel-17, enhancement towards DRX for RRC_IDLE/RRC_INACTIVE mode (e.g., I-DRX) was introduced, wherein a paging early indication (PEI) was used for a UE to skip monitoring paging occasions such that extra power saving gain could be achieved.

However, embodiments of the present disclosure recognize that the UE still needs to frequently wake up to monitor the new DCI format or the PEI, such that the radio of the UE cannot be fully turned off for a long duration. To avoid such situation and to acquire further power saving gain, an additional receiver radio is provided, wherein the additional receiver radio can be used for monitor a particular set of signals with very low power consumption, and the main receiver radio can be turned off or operating with a very lower power for a long duration. For one example, the low power signals can include a wake up signal (WUS) or also referred to as a low power wake up signal (LP-WUS), e.g., a low power signal for waking up the main receiver and/or for PDCCH monitoring.

Aspects of this disclosure discuss the PDCCH monitoring triggered by WUS. Further, embodiments and examples of this disclosure can be applicable when DRX operation is configured for the serving cell, e.g., for RRC_CONNECTED mode.

Aspects of this disclosure discuss on PDCCH monitoring triggered by LP-WUS. More precisely, the following aspects are included in the disclosure:
Determination of timing to start a timer for PDCCH monitoring
   Based on the timing of the received LP-WUS
   Based on the configuration of PDCCH monitoring occasions
   Based on both the DRX configuration
   Based on the DRX configuration and the configuration of PDCCH monitoring occasions
   Based on a time offset from the received LP-WUS.
Determination of the duration of the timer
Determination of the type of PDCCH to monitor when the timer runs
Example UE procedure

In one embodiment, after a UE (e.g., the UE 116) receives a LP-WUS indicating to wake up MR operation (e.g., at least to monitor PDCCH), the UE can determine to start a timer to be associated with the MR operation (e.g., at least PDCCH monitoring). The timing to determine to start the timer for the MR operation (e.g., at least PDCCH monitoring) can be according to at least one example in the embodiment.

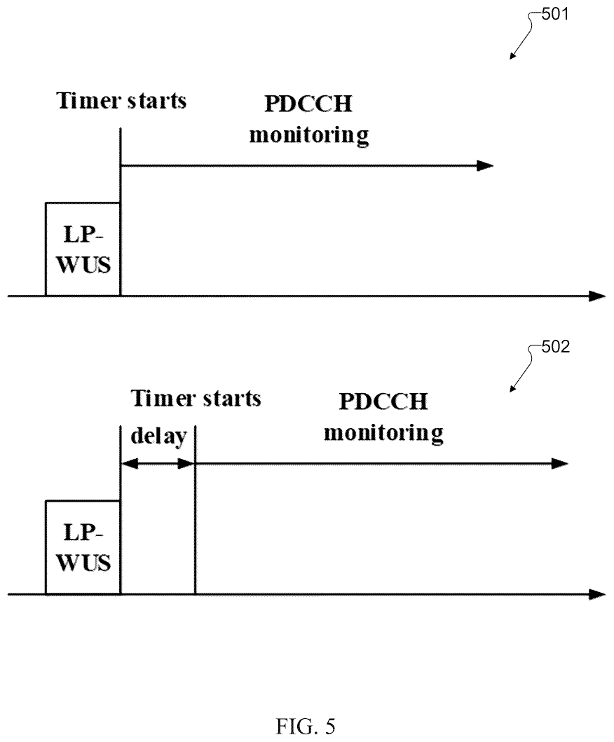

FIG. 5 illustrates timelines 501 and 502 for starting an example timer for PDCCH monitoring according to embodiments of the present disclosure. For example, timelines 501 and 502 can be followed by any of the UEs 111-116 of FIG. 1. This example is for illustration only and other embodiments can be used without departing from the scope of the present disclosure.

For one example (e.g., 501 of FIG. 5), the UE can determine to start the timer at the ending or starting instance of a time unit or the last time unit within the time units including the received LP-WUS.
For one sub-example, the time unit can be a OFDM symbol.
For another sub-example, the time unit can be a slot.
For yet another sub-example, the time unit can be a subframe (e.g., ms).
For yet another sub-example, the time unit can be a time domain window for monitoring LP-WUS (e.g., the time domain window configuration can be according to an example of this disclosure).
For one further implementation, this example can be applicable when the received LP-WUS is located within (or ending in) the ON duration of the DRX cycle (e.g., determined by drx-onDuration Timer).
For another further implementation, this example can be applicable when the received LP-WUS is located outside (or ending outside) the ON duration of the DRX cycle (e.g., determined by drx-onDurationTimer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

For another example (e.g., 502 of FIG. 5), the UE can determine to start the timer at the time instance with a delay from the ending or starting instance of a time unit or the last time unit within time units including the received LP-WUS.
For one sub-example, the time unit can be a OFDM symbol.
For another sub-example, the time unit can be a slot.
For yet another sub-example, the time unit can be a subframe (e.g., ms).
For yet another sub-example, the time unit can be a time domain window for monitoring LP-WUS (e.g., the time domain window configuration can be according to an example of this disclosure).
For one sub-example, the delay can be fixed or pre-defined, e.g., corresponding to a minimum processing time of the LP-WUS.
For another sub-example, the delay can be configured by the BS, e.g., in system information or dedicated RRC parameter.
For yet another sub-example, the delay can be determined by the BS based on UE capability reporting of a minimum delay requirement (e.g., the delay is not less than the reported minimum delay requirement).
For yet another sub-example, a value of the preferred delay can be indicated by the UE in UE assistant information.
For one further implementation, this example can be applicable when the received LP-WUS is located within (or ending in) the ON duration of the DRX cycle (e.g., determined by drx-onDuration Timer).
For another further implementation, this example can be applicable when the received LP-WUS is located outside (or ending outside) the ON duration of the DRX cycle (e.g., determined by drx-onDurationTimer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

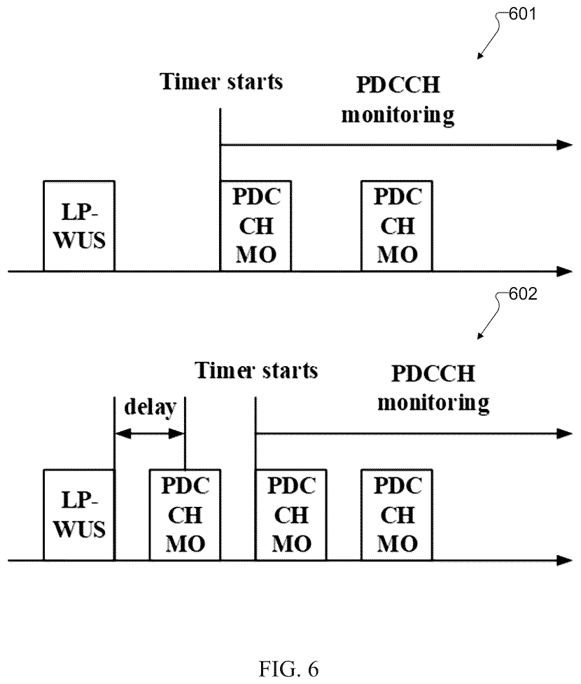

FIG. 6 illustrates timelines 601 and 602 for starting an example timer for PDCCH monitoring according to embodiments of the present disclosure. For example, timelines 601 and 602 can be followed by any of the UEs 111-116 of FIG. 1, such as the UE 111. This example is for illustration only and other embodiments can be used without departing from the scope of the present disclosure.

For one example (e.g., 601 of FIG. 6), the UE can determine to start the timer at the starting instance of the first PDCCH monitoring occasion after the ending or starting instance of a time unit or the last time unit within the time units including the received LP-WUS.
For one further implementation, the PDCCH monitoring occasion is determined based on the search space set configuration.
For one further implementation, the time unit can be according to examples of this disclosure.
   For one sub-example, the time unit can be a OFDM symbol.
   For another sub-example, the time unit can be a slot.
   For yet another sub-example, the time unit can be a subframe (e.g., ms).
   For yet another sub-example, the time unit can be a time domain window for monitoring LP-WUS (e.g., the time domain window configuration can be according to an example of this disclosure).
For one further implementation, this example can be applicable when the PDCCH monitoring occasion further satisfies that the corresponding search space set is a Type3-PDCCH common search space (CSS) set.
   For one instance, the corresponding DCI format with the PDCCH can be a DCI format 2_0, which is used for notifying the slot format, COT duration, available resource block (RB) set, and search space set group switching.
   For another instance, the corresponding DCI format with the PDCCH can be a DCI format 2_6, which is used for notifying the power saving information outside DRX Active Time for one or more UEs.
   For yet another instance, the corresponding DCI format with the PDCCH can be a DCI format 2_7, which is used for notifying the paging early indication and tracking reference signal (TRS) availability indication for one or more UEs.
   For yet another instance, the corresponding DCI format with the PDCCH can be a DCI format 2_9, which is used for activating or de-activating the cell discontinuous transmission (DTX) and/or DRX configuration of one or multiple serving cells for one or more UEs, and/or for providing network energy savings (NES)-mode indication of the primary cell for one or more UEs.
For another further implementation, this example can be applicable when the PDCCH monitoring occasion further satisfies that the corresponding search space set is a UE-specific search space (USS) set.
   For one instance, the corresponding DCI format with the PDCCH can be a DCI format 0_x (e.g., 0_0, or 0_1, or 0_2, or 0_3), which is used for scheduling of physical uplink shared channel (PUSCH).
   For another instance, the corresponding DCI format with the PDCCH can be a DCI format 1_x (e.g., 1_0, or 1_1, or 1_2, or 1_3), which is used for scheduling of physical downlink shared channel (PDSCH).
   For yet another instance, the corresponding DCI format with the PDCCH can be a DCI format 3_x (e.g., 3_0, or 3_1, or 3_2), which is used for scheduling of sidelink transmissions.
For yet another further implementation, this example can be applicable when the PDCCH monitoring occasion further satisfies that the corresponding search space set is configured by the BS to be associated with the LP-WUS wake-up indication.
   For one instance, a search space set configuration can be associated with an indication that whether the LP-WUS can trigger monitoring of the corresponding search space set.
   For another instance, a configuration for LP-WUS can be associated with an indication that which search space sets can be triggered by LP-WUS to monitor PDCCH accordingly.
For one further implementation, this example can be applicable when the received LP-WUS is located within (or ending in) the ON duration of the DRX cycle (e.g., determined by drx-onDurationTimer).
For another further implementation, this example can be applicable when the received LP-WUS is located outside (or ending outside) the ON duration of the DRX cycle (e.g., determined by drx-onDuration Timer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

For another example (e.g., 602 of FIG. 6), the UE can determine to start the timer at the starting instance of the first PDCCH monitoring occasion after the ending or starting instance of a first time unit or the last time unit within the first time units including the received LP-WUS, which is also after a delay with respect to the ending or starting instance of a second time unit or the last time unit within the second time units including the received LP-WUS.
For one sub-example, the delay is with respect to the last OFDM symbol within the OFDM symbol(s) including the received LP-WUS.
For one further implementation, the first time unit can be according to examples of this disclosure.
   For one sub-example, the first time unit can be a OFDM symbol.
   For another sub-example, the first time unit can be a slot.
   For yet another sub-example, the first time unit can be a subframe (e.g., ms).
   For yet another sub-example, the first time unit can be a time domain window for monitoring LP-WUS (e.g., the time domain window configuration can be according to an example of this disclosure).
   For another further implementation, the second time unit can be according to examples of this disclosure. For one sub-example, the second time unit can be a OFDM symbol.
   For another sub-example, the second time unit can be a slot.
   For yet another sub-example, the second time unit can be a subframe (e.g., ms).
For yet another sub-example, the second time unit can be a time domain window for monitoring LP-WUS (e.g., the time domain window configuration can be according to an example of this disclosure).
For another sub-example, the delay is with respect to the last slot within the slot(s) including the received LP-WUS.
For yet another sub-example, the delay is with respect to the last subframe (e.g., ms) within the subframe(s) including the received LP-WUS.
For yet another sub-example, the delay is with respect to the starting or ending instance of the time domain window for monitoring occasions of the LP-WUS, which includes the received LP-WUS.
For one sub-example, the delay can be fixed or pre-defined, e.g., corresponding to a minimum processing time of the LP-WUS.
For another sub-example, the delay can be configured by the BS, e.g., in system information or dedicated RRC parameter.
For yet another sub-example, the delay can be determined by the BS based on UE capability reporting of a minimum delay requirement (e.g., the delay is not less than the reported minimum delay requirement).
For yet another sub-example, a value of the preferred delay can be indicated by the UE in UE assistant information.
For one further implementation, the PDCCH monitoring occasion is determined based on the search space set configuration.
For one further implementation, this example can be applicable when the PDCCH monitoring occasion further satisfies that the corresponding search space set is a Type3-PDCCH CSS set.
   For one instance, the corresponding DCI format with the PDCCH can be a DCI format 2_0, which is used for notifying the slot format, COT duration, available RB set, and search space set group switching.
   For another instance, the corresponding DCI format with the PDCCH can be a DCI format 2_6, which is used for notifying the power saving information outside DRX Active Time for one or more UEs.
   For yet another instance, the corresponding DCI format with the PDCCH can be a DCI format 2_7, which is used for notifying the paging early indication and TRS availability indication for one or more UEs.
   For yet another instance, the corresponding DCI format with the PDCCH can be a DCI format 2_9, which is used for activating or de-activating the cell DTX and/or DRX configuration of one or multiple serving cells for one or more UEs, and/or for providing NES-mode indication of the primary cell for one or more UEs.
For another further implementation, this example can be applicable when the PDCCH monitoring occasion further satisfies that the corresponding search space set is a USS set.
   For one instance, the corresponding DCI format with the PDCCH can be a DCI format 0_x (e.g., 0_0, or 0_1, or 0_2, or 0_3), which is used for scheduling of PUSCH.
   For another instance, the corresponding DCI format with the PDCCH can be a DCI format 1_x (e.g., 1_0, or 1_1, or 1_2, or 1_3), which is used for scheduling of PDSCH.
   For yet another instance, the corresponding DCI format with the PDCCH can be a DCI format 3_x (e.g., 3_0, or 3_1, or 3_2), which is used for scheduling of sidelink transmissions.
For yet another further implementation, this example can be applicable when the PDCCH monitoring occasion further satisfies that the corresponding search space set is configured by the BS to be associated with the LP-WUS wake-up indication.
   For one instance, a search space set configuration can be associated with an indication that whether the LP-WUS can trigger monitoring of the corresponding search space set.
   For another instance, a configuration for LP-WUS can be associated with an indication that which search space sets can be triggered by LP-WUS to monitor PDCCH accordingly.
For one further implementation, this example can be applicable when the received LP-WUS is located within (or ending in) the ON duration of the DRX cycle (e.g., determined by drx-onDuration Timer).
For another further implementation, this example can be applicable when the received LP-WUS is located outside (or ending outside) the ON duration of the DRX cycle (e.g., determined by drx-onDurationTimer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

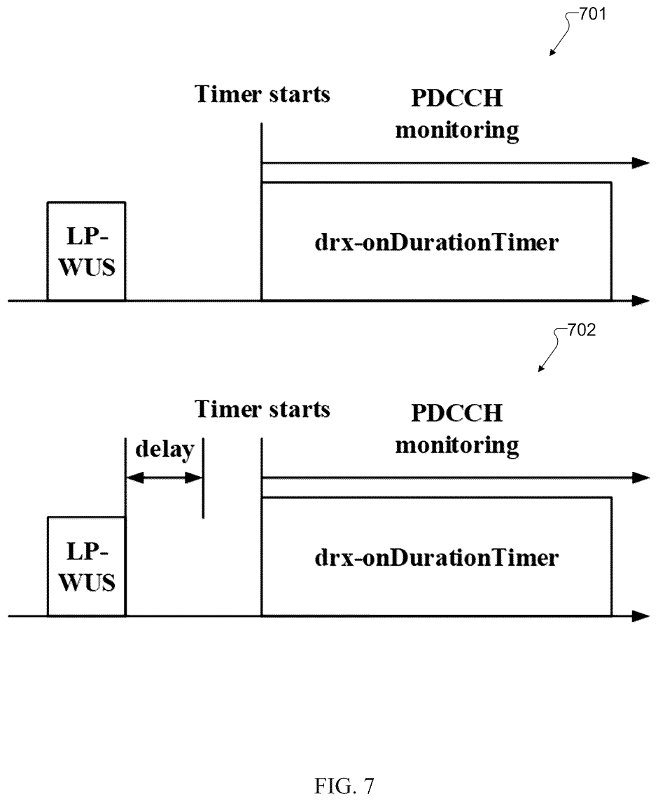

FIG. 7 illustrates timelines 701 and 702 for starting an example timer for PDCCH monitoring according to embodiments of the present disclosure. For example, timelines 701 and 702 can be followed by any of the UEs 111-116 of FIG. 1, such as the UE 112. This example is for illustration only and other embodiments can be used without departing from the scope of the present disclosure.

For one example (e.g., 701 of FIG. 7), the UE can determine to start the timer at the starting instance of the first ON duration of the DRX cycle (e.g., determined by drx-onDurationTimer) after the received LP-WUS.
For one further implementation, this example can be applicable when the received LP-WUS is located within (or ending in) the ON duration of the DRX cycle (e.g., determined by drx-onDurationTimer).
For another further implementation, this example can be applicable when the received LP-WUS is located outside (or ending outside) the ON duration of the DRX cycle (e.g., determined by drx-onDurationTimer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

For another example (e.g., 702 of FIG. 7), the UE can determine to start the timer at the starting instance of the first ON duration of the DRX cycle (e.g., determined by drx-onDurationTimer) after the received LP-WUS and after a delay with respect to the received LP-WUS.
For one sub-example, the delay is with respect to the last OFDM symbol within the OFDM symbol(s) including the received LP-WUS.
For another sub-example, the delay is with respect to the last slot within the slot(s) including the received LP-WUS.
For yet another sub-example, the delay is with respect to the last subframe (e.g., ms) within the subframe(s) including the received LP-WUS.
For one sub-example, the delay can be fixed or pre-defined, e.g., corresponding to a minimum processing time of the LP-WUS.
For another sub-example, the delay can be configured by the BS, e.g., in system information or dedicated RRC parameter.
For yet another sub-example, the delay can be determined by the BS based on UE (e.g., the UE 116) capability reporting.
For one further implementation, this example can be applicable when the received LP-WUS is located within (or ending in) the ON duration of the DRX cycle (e.g., determined by drx-onDuration Timer).
For another further implementation, this example can be applicable when the received LP-WUS is located outside (or ending outside) the ON duration of the DRX cycle (e.g., determined by drx-onDuration Timer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

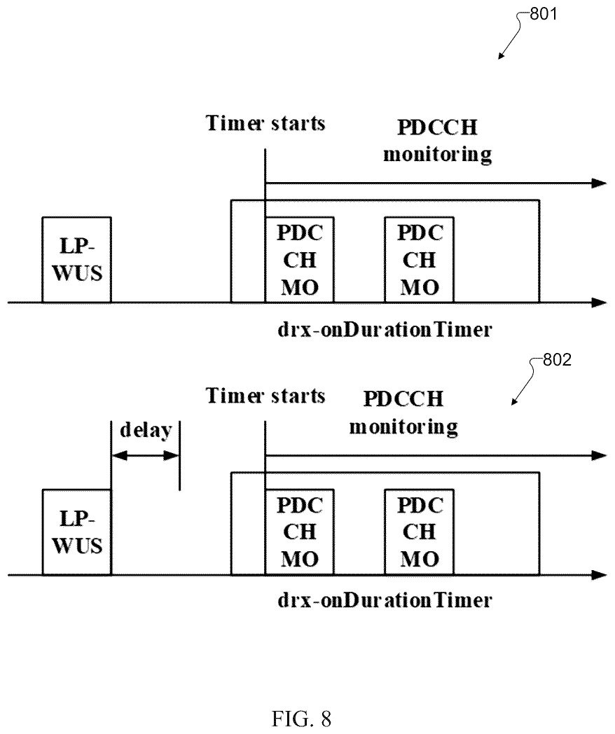

FIG. 8 illustrates timelines 801 and 802 for starting an example timer for PDCCH monitoring according to embodiments of the present disclosure. For example, timelines 801 and 802 can be followed by any of the UEs 111-116 of FIG. 1, such as the UE 113. This example is for illustration only and other embodiments can be used without departing from the scope of the present disclosure.

For one example (e.g., 801 of FIG. 8), the UE can determine to start the timer at the starting instance of the first PDCCH monitoring occasion in the first ON duration of the DRX cycle (e.g., determined by drx-onDurationTimer) after the received LP-WUS.
For one further implementation, the PDCCH monitoring occasion is determined based on the search space set configuration.
For one further implementation, this example can be applicable when the PDCCH monitoring occasion further satisfies that the corresponding search space set is a Type3-PDCCH CSS set.
   For one instance, the corresponding DCI format with the PDCCH can be a DCI format 2_0, which is used for notifying the slot format, COT duration, available RB set, and search space set group switching.
   For another instance, the corresponding DCI format with the PDCCH can be a DCI format 2_6, which is used for notifying the power saving information outside DRX Active Time for one or more UEs.
   For yet another instance, the corresponding DCI format with the PDCCH can be a DCI format 2_7, which is used for notifying the paging early indication and TRS availability indication for one or more UEs.
   For yet another instance, the corresponding DCI format with the PDCCH can be a DCI format 2_9, which is used for activating or de-activating the cell DTX and/or DRX configuration of one or multiple serving cells for one or more UEs, and/or for providing NES-mode indication of the primary cell for one or more UEs.
For another further implementation, this example can be applicable when the PDCCH monitoring occasion further satisfies that the corresponding search space set is a USS set.
   For one instance, the corresponding DCI format with the PDCCH can be a DCI format 0_x (e.g., 0_0, or 0_1, or 0_2, or 0_3), which is used for scheduling of PUSCH.
   For another instance, the corresponding DCI format with the PDCCH can be a DCI format 1_x (e.g., 1_0, or 1_1, or 1_2, or 1_3), which is used for scheduling of PDSCH.
   For yet another instance, the corresponding DCI format with the PDCCH can be a DCI format 3_x (e.g., 3_0, or 3_1, or 3_2), which is used for scheduling of sidelink transmissions.
For yet another further implementation, this example can be applicable when the PDCCH monitoring occasion further satisfies that the corresponding search space set is configured by the BS to be associated with the LP-WUS wake-up indication.
   For one instance, a search space set configuration can be associated with an indication that whether the LP-WUS can trigger monitoring of the corresponding search space set.
   For another instance, a configuration for LP-WUS can be associated with an indication that which search space sets can be triggered by LP-WUS to monitor PDCCH accordingly.
For one further implementation, this example can be applicable when the received LP-WUS is located within (or ending in) the ON duration of the DRX cycle (e.g., determined by drx-onDurationTimer).
For another further implementation, this example can be applicable when the received LP-WUS is located outside (or ending outside) the ON duration of the DRX cycle (e.g., determined by drx-onDurationTimer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

For another example (e.g., 802 of FIG. 8), the UE can determine to start the timer at the starting instance of the first PDCCH monitoring occasion in the first ON duration of the DRX cycle (e.g., determined by drx-onDurationTimer) after the received LP-WUS and after a delay with respect to the received LP-WUS.
For one sub-example, the delay is with respect to the last OFDM symbol within the OFDM symbol(s) including the received LP-WUS.
For another sub-example, the delay is with respect to the last slot within the slot(s) including the received LP-WUS.
For yet another sub-example, the delay is with respect to the last subframe (e.g., ms) within the subframe(s) including the received LP-WUS.
For one sub-example, the delay can be fixed or pre-defined, e.g., corresponding to a minimum processing time of the LP-WUS.
For another sub-example, the delay can be configured by the BS, e.g., in system information or dedicated RRC parameter.
For yet another sub-example, the delay can be determined by the BS based on UE capability reporting.
For one further implementation, the PDCCH monitoring occasion is determined based on the search space set configuration.
For one further implementation, this example can be applicable when the PDCCH monitoring occasion further satisfies that the corresponding search space set is a Type3-PDCCH CSS set.
   For one instance, the corresponding DCI format with the PDCCH can be a DCI format 2_0, which is used for notifying the slot format, COT duration, available RB set, and search space set group switching.
   For another instance, the corresponding DCI format with the PDCCH can be a DCI format 2_6, which is used for notifying the power saving information outside DRX Active Time for one or more UEs.
   For yet another instance, the corresponding DCI format with the PDCCH can be a DCI format 2_7, which is used for notifying the paging early indication and TRS availability indication for one or more UEs.
   For yet another instance, the corresponding DCI format with the PDCCH can be a DCI format 2_9, which is used for activating or de-activating the cell DTX and/or DRX configuration of one or multiple serving cells for one or more UEs, and/or for providing NES-mode indication of the primary cell for one or more UEs.
For another further implementation, this example can be applicable when the PDCCH monitoring occasion further satisfies that the corresponding search space set is a USS set.
   For one instance, the corresponding DCI format with the PDCCH can be a DCI format 0_x (e.g., 0_0, or 0_1, or 0_2, or 0_3), which is used for scheduling of PUSCH.
   For another instance, the corresponding DCI format with the PDCCH can be a DCI format 1_x (e.g., 1_0, or 1_1, or 1_2, or 1_3), which is used for scheduling of PDSCH.
   For yet another instance, the corresponding DCI format with the PDCCH can be a DCI format 3_x (e.g., 3_0, or 3_1, or 3_2), which is used for scheduling of sidelink transmissions.
For yet another further implementation, this example can be applicable when the PDCCH monitoring occasion further satisfies that the corresponding search space set is configured by the BS to be associated with the LP-WUS wake-up indication.
   For one instance, a search space set configuration can be associated with an indication that whether the LP-WUS can trigger monitoring of the corresponding search space set.
   For another instance, a configuration for LP-WUS can be associated with an indication that which search space sets can be triggered by LP-WUS to monitor PDCCH accordingly.
For one further implementation, this example can be applicable when the received LP-WUS is located within (or ending in) the ON duration of the DRX cycle (e.g., determined by drx-onDuration Timer).
For another further implementation, this example can be applicable when the received LP-WUS is located outside (or ending outside) the ON duration of the DRX cycle (e.g., determined by drx-onDurationTimer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

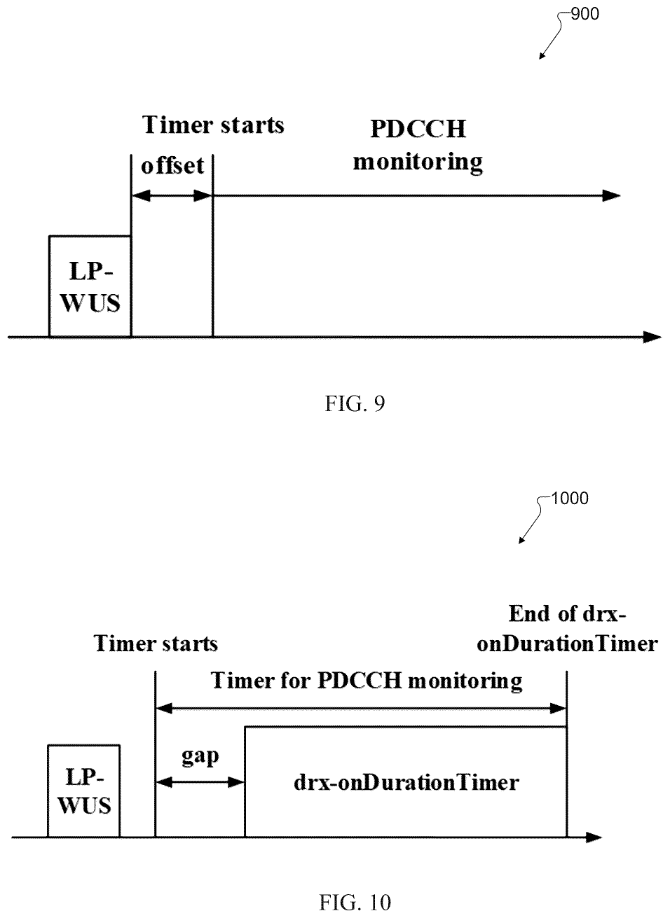

FIG. 9 illustrates a timeline 900 for starting an example timer for PDCCH monitoring according to embodiments of the present disclosure. For example, timeline 900 can be followed by any of the UEs 111-116 of FIG. 1, such as the UE 114. This example is for illustration only and other embodiments can be used without departing from the scope of the present disclosure.

For one example (e.g., 900 of FIG. 9), the UE can determine to start the timer at the time instance with a time offset with respect to the ending or starting instance of a time unit or the last time unit within the time units including the received LP-WUS.
For one sub-example, the time offset is with respect to the last OFDM symbol within the OFDM symbol(s) including the received LP-WUS.
For one sub-example, the time unit can be a OFDM symbol.
For another sub-example, the time unit can be a slot.
For yet another sub-example, the time unit can be a subframe (e.g., ms).
For yet another sub-example, the time unit can be a time domain window for monitoring LP-WUS (e.g., the time domain window configuration can be according to an example of this disclosure).
For another sub-example, the time offset is with respect to the last slot within the slot(s) including the received LP-WUS.
For yet another sub-example, the time offset is with respect to the last subframe (e.g., ms) within the subframe(s) including the received LP-WUS.
For yet another sub-example, the time offset is with respect to the starting or ending instance of the time domain window for monitoring occasions of the LP-WUS, which includes the received LP-WUS.
For yet another sub-example, the time offset is with respect to the starting or ending instance of the first MO for LP-WUS within the time domain window for MOs of the LP-WUS, wherein the time domain window includes the received LP-WUS.
For yet another sub-example, the time offset is with respect to the starting or ending instance of the last MO for LP-WUS within the time domain window for MOs of the LP-WUS, wherein the time domain window includes the received LP-WUS.
For one sub-example, the time offset can be fixed or pre-defined, e.g., corresponding to a minimum processing time of the LP-WUS.
For another sub-example, the time offset can be configured by the BS, e.g., in system information or dedicated RRC parameter.
For yet another sub-example, the time offset can be determined by the BS based on at least one UE capability reporting of a minimum delay requirement (e.g., the time offset is not less than the reported minimum delay requirement).
For yet another sub-example, a value of the preferred time offset can be indicated by the UE in UE assistant information.
For yet another sub-example, the time offset can be indicated by the received LP-WUS.
For one further implementation, the time offset can be expected to be no less than (or larger than) a predefined delay, e.g., corresponding to a minimum processing time of the LP-WUS.
For one further implementation, this example can be applicable when the received LP-WUS is located within (or ending in) the ON duration of the DRX cycle (e.g., determined by drx-onDuration Timer).
For another further implementation, this example can be applicable when the received LP-WUS is located outside (or ending outside) the ON duration of the DRX cycle (e.g., determined by drx-onDurationTimer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

FIG. 10 illustrates a timeline 1000 for starting an example timer for PDCCH monitoring according to embodiments of the present disclosure. For example, timeline 1000 can be followed by any of the UEs 111-116 of FIG. 1, such as the UE 115. This example is for illustration only and other embodiments can be used without departing from the scope of the present disclosure.

In one embodiment, after a UE receives a LP-WUS indicating to wake up MR operation (e.g., at least to monitor PDCCH), the UE can determine to start a timer to be associated with the MR operation (e.g., at least PDCCH monitoring). The determination of the timer can be according to at least one example in the embodiment, and can be combined with other embodiments of this disclosure.

For one example, the timer (e.g., at least for PDCCH monitoring) can be ON duration timer (e.g., drx-onDurationTimer).
For one further implementation, this example can be applicable when the received LP-WUS is located within (or ending in) the ON duration of the DRX cycle (e.g., determined by drx-onDuration Timer).
For another further implementation, this example can be applicable when the received LP-WUS is located outside (or ending outside) the ON duration of the DRX cycle (e.g., determined by drx-onDuration Timer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

For another example, the timer (e.g., at least for PDCCH monitoring) can be Inactivity timer (e.g., drx-Inactivity Timer).
For one further implementation, this example can be applicable when the received LP-WUS is located within (or ending in) the ON duration of the DRX cycle (e.g., determined by drx-onDuration Timer).
For another further implementation, this example can be applicable when the received LP-WUS is located outside (or ending outside) the ON duration of the DRX cycle (e.g., determined by drx-onDurationTimer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

For yet another example, the timer (e.g., at least for PDCCH monitoring) can be a new timer (e.g., timer other than drx-InactivityTimer or drx-onDurationTimer).
For one instance, the new timer can be configured by the BS by higher layer parameter.
For another instance, the new timer can be indicated by the received LP-WUS.
For one further implementation, this example can be applicable when the received LP-WUS is located within (or ending in) the ON duration of the DRX cycle (e.g., determined by drx-onDuration Timer).
For another further implementation, this example can be applicable when the received LP-WUS is located outside (or ending outside) the ON duration of the DRX cycle (e.g., determined by drx-onDurationTimer).
For one further implementation, this example can be applicable when the received LP-WUS is located within (or ending in) the active time of the DRX operation, if the UE (e.g., the UE 116) is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

For yet another example, the timer (e.g., at least for PDCCH monitoring) can be determined as a sum of a ON duration timer (e.g., drx-onDurationTimer) and a gap duration between the time instance to start the timer (e.g., according to example of this disclosure) and the starting instance of the ON duration (e.g., determined based on drx-onDurationTimer). An illustration of this example is shown in FIG. 10.
For one further implementation, this example can be applicable when the received LP-WUS is located outside (or ending outside) the ON duration of the DRX cycle (e.g., determined by drx-onDurationTimer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

FIG. 11 illustrates an example timer/time window determination 1100 according to embodiments of the present disclosure. For example, timer/time window determination 1100 can be utilized by the UE 116 of FIG. 3. This example is for illustration only and other embodiments can be used without departing from the scope of the present disclosure.

For yet another example, the timer (e.g., at least for PDCCH monitoring) can be determined as a ON duration timer (e.g., drx-onDurationTimer) minus a gap duration between the time instance to start the timer (e.g., according to example of this disclosure) and the starting instance of the ON duration (e.g., determined based on drx-onDurationTimer). An illustration of this example is shown in FIG. 11.
For one further implementation, this example can be applicable when the received LP-WUS is located within (or ending in) the ON duration of the DRX cycle (e.g., determined by drx-onDurationTimer).
For one further implementation, this example can be applicable when the received LP-WUS is located within (or ending in) the active time of the DRX operation if the UE is required/expected/configured to monitor LP-WUS in the active time of the DRX operation.
For another further implementation, this example can be applicable when the received LP-WUS is located within (or ending in) the non-active time of the DRX operation, if the UE is required/expected/configured to monitor LP-WUS in the non-active time of the DRX operation.

In one embodiment, after a UE receives a LP-WUS indicating to wake up MR operation (e.g., at least to monitor PDCCH), the UE can determine to start a timer to be associated with the MR operation (e.g., at least PDCCH monitoring). The type of PDCCH to monitor can be according to at least one example in the embodiment, and can be combined with other embodiments of this disclosure.

For one example, the PDCCH to monitor triggered by LP-WUS can be the one with its search space set as a Type3-PDCCH CSS set.
For one instance, the corresponding DCI format with the PDCCH can be a DCI format 2_0, which is used for notifying the slot format, COT duration, available RB set, and search space set group switching.
For another instance, the corresponding DCI format with the PDCCH can be a DCI format 2_6, which is used for notifying the power saving information outside DRX Active Time for one or more UEs.
For yet another instance, the corresponding DCI format with the PDCCH can be a DCI format 2_7, which is used for notifying the paging early indication and TRS availability indication for one or more UEs.
For yet another instance, the corresponding DCI format with the PDCCH can be a DCI format 2_9, which is used for activating or de-activating the cell DTX and/or DRX configuration of one or multiple serving cells for one or more UEs, and/or for providing NES-mode indication of the primary cell for one or more UEs.

For another example, the PDCCH to monitor triggered by LP-WUS can be the one with its search space set as a USS set.
For one instance, the corresponding DCI format with the PDCCH can be a DCI format 0_x (e.g., 0_0, or 0_1, or 0_2, or 0_3), which is used for scheduling of PUSCH.
For another instance, the corresponding DCI format with the PDCCH can be a DCI format 1_x (e.g., 1_0, or 1_1, or 1_2, or 1_3), which is used for scheduling of PDSCH.
For yet another instance, the corresponding DCI format with the PDCCH can be a DCI format 3_x (e.g., 3_0, or 3_1, or 3_2), which is used for scheduling of sidelink transmissions.

For yet another example, the PDCCH to monitor triggered by LP-WUS can be the one with its search space set configured by the BS to be associated with the LP-WUS wake-up indication.
For one instance, a search space set configuration can be associated with an indication that whether the LP-WUS can trigger monitoring of the corresponding search space set.
For another instance, a configuration for LP-WUS can be associated with an indication that which search space sets can be triggered by LP-WUS to monitor PDCCH accordingly.

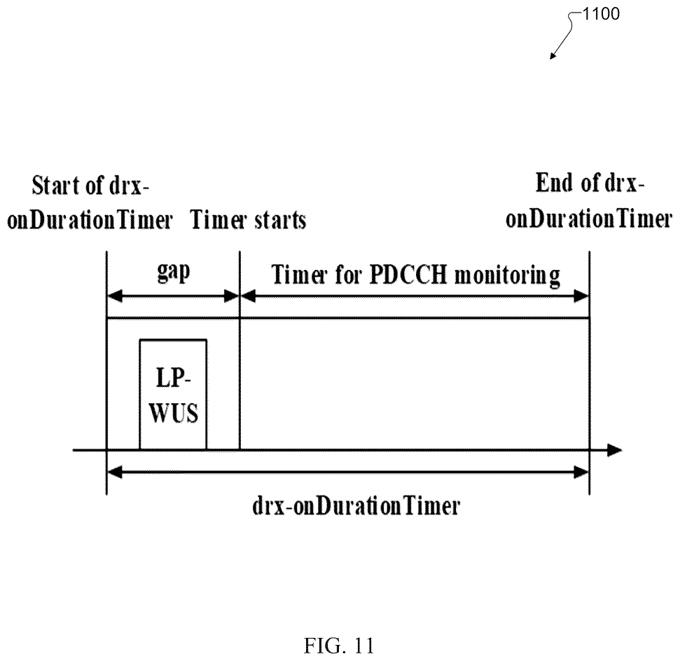

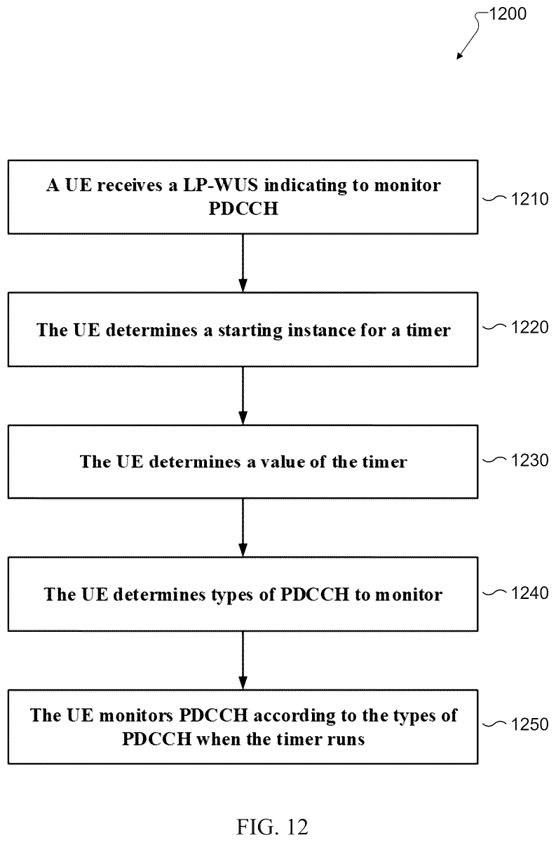

FIG. 12 illustrates an example UE procedure 1200 for PDCCH monitoring triggered by LP-WUS according to embodiments of the present disclosure. For example, procedure 1200 can be performed by the UE 116 of FIG. 3. This example is for illustration only and other embodiments can be used without departing from the scope of the present disclosure.

The procedure begins in 1210, a UE receives a LP-WUS indicating to monitor PDCCH. In 1220, the UE determines a starting instance for a timer. In 1230, the UE determines a value of the timer, in 1240, the UE determines types of PDCCH to monitor. In 1250, the UE monitors PDCCH according to the types of PDCCH when the timer runs.

In one embodiment, an example UE procedure for PDCCH monitoring triggered by LP-WUS is shown in FIG. 12.

In one embodiment, a UE can be provided with a transmission configuration indication (TCI) state or a quasi-co-location (QCL) source when the UE is provided with a configuration of a LP-WUS, wherein the TCI state can include a reference signal as the QCL source.

For one example, the QCL source can be determined by at least one from a synchronization signal block (SSB) index, or a channel state information reference signal (CSI-RS) resource index, or a low power state saving (LP-SS) index.

For another example, this embodiment can be applicable at least for RRC_CONNECTED mode.

For yet another example, this embodiment can be applicable at least for the active DL bandwidth part (BWP).

For yet another example, this embodiment can be applicable when the unified TCI framework is not applicable (e.g., when the UE is not capable of the unified TCI framework and/or when the unified TCI framework is not configured, such as when a higher layer parameter (e.g., dl-OrJointTCI-StateList) is not configured to the UE).

For yet another example, a CORESET ID can be used to represent a TCI state or a QCL source, wherein the TCI state or the QCL source can be determined to be associated with the CORESET, e.g., as in the way such as by a MAC CE for the Indication of TCI state for UE-specific PDCCH, or by association with SSB or CSI-RS when the MAC CE is not available.

In one embodiment, a UE can determine a QCL source of a LP-WUS based on the unified TCI framework (e.g., when the UE is capable of the unified TCI framework and/or when the unified TCI framework is configured, such as when a higher layer parameter (e.g., dl-OrJointTCI-StateList) is configured to the UE).

For one example, the QCL source can be determined by at least one from a SSB index, a CSI-RS resource index, or a LP-SS index.

For another example, this embodiment can be applicable at least for RRC_CONNECTED mode.

For yet another example, this embodiment can be applicable at least for the active DL BWP.

For yet another example, in the unified TCI framework, the UE can be provided with a first list of candidate TCI states by higher layer parameters (e.g., RRC parameters), and provided a second list of activated TCI states based on the first list of the candidate TCI states (e.g., selected as a subset) by a MAC CE, and indicated one of the activated TCI states that is applicable at least for LP-WUS (e.g., may also be applicable for PDCCH, and/or PDSCH, and/or other DL signal or channel) by a DCI format.
For one instance, the higher layer parameter may provide one candidate TCI state and activate it directly, e.g., without the MAC CE or the DCI format.
For another instance, the MAC CE may provide one candidate TCI state and activate it directly, e.g., without the DCI format.

For yet another example, when the UE receives a DCI format (or the MAC CE when there is one candidate TCI state provided by the MAC CE, or the RRC when there is one candidate TCI state provided by the RRC) indicating an applicable TCI state, the UE applies the indicated TCI state to receive the LP-WUS(s) after a time delay (e.g., beam application time). For instance, the LP-WUS(s) include all LP-WUS immediately after the time delay.

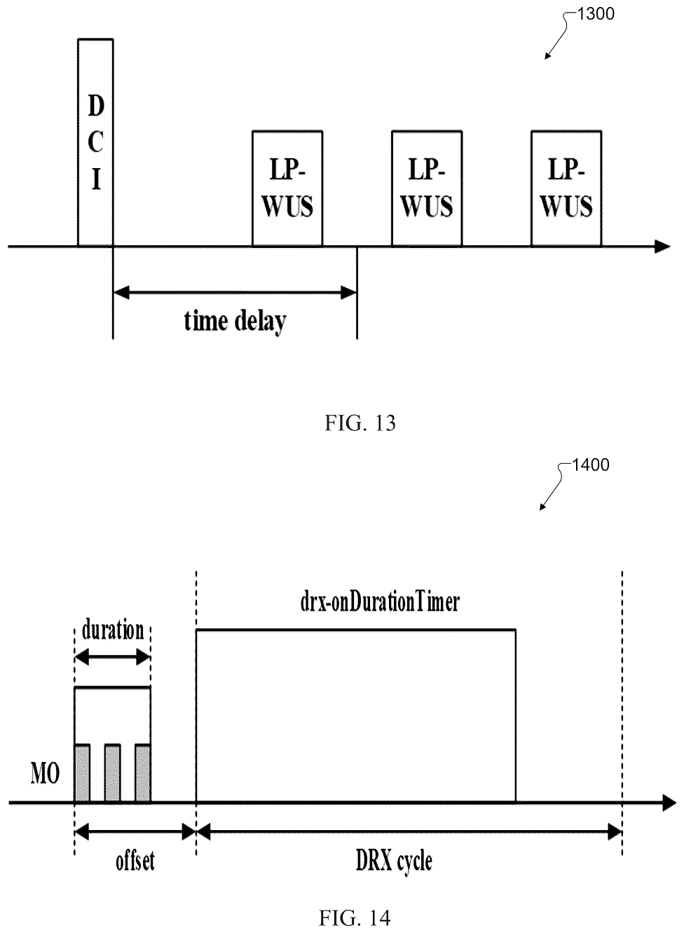

FIG. 13 illustrates a timeline 1300 of an example application time delay indicated by a DCI format according to embodiments of the present disclosure. For example, timeline 1300 can be followed by an of the UEs 111-116 of FIG. 1, such as the UE 116. This example is for illustration only and other embodiments can be used without departing from the scope of the present disclosure.

For yet another example, if a LP-WUS is within or overlapping with the time delay to apply a TCI state indicated by the DCI format (e.g., as shown in FIG. 13), the QCL source of the LP-WUS can be determined by at least one of the following instances:
In a first instance, the QCL source of the LP-WUS can be determined by a previous DCI format indicating the TCI state and the LP-WUS is after the corresponding time delay.
In a second instance, the QCL source of the LP-WUS can be determined by a default QCL source provided by higher layer parameter. For one further implementation, this instance can be applicable when the first instance is not applicable (e.g., when there is no previous DCI format).
In a third instance, the QCL source of the LP-WUS can be determined as the QCL source used for random access procedure (e.g., for RRC connection). For one further implementation, this instance can be applicable when the first instance is not applicable (e.g., when there is no previous DCI format).
In a fourth instance, the QCL source of the LP-WUS can be determined as the QCL source used for a reception of the DCI format. For one further implementation, this instance can be applicable when the first instance is not applicable (e.g., when there is no previous DCI format).
In a fifth instance, the QCL source of the LP-WUS can be determined as the QCL source used for a reception of a previous PDCCH or PDSCH, e.g., before the monitoring occasion of the LP-WUS. For one further implementation, this instance can be applicable when the first instance is not applicable (e.g., when there is no previous DCI format).
In a sixth instance, the QCL source of the LP-WUS can be determined as the QCL source used for a CORESET with the lowest index. For one further implementation, this instance can be applicable when the first instance is not applicable (e.g., when there is no previous DCI format).
In a seventh instance, the QCL source of the LP-WUS can be determined as the QCL source used for a reception of PDCCH that the LP-WUS is indicating to wake up and monitor.

FIG. 14 illustrates a timeline 1400 of an example time domain window for MOs of LP-WUS according to embodiments of the present disclosure. For example, timeline 1400 can be followed by an of the UEs 111-116 of FIG. 1, such as the UE 111. This example is for illustration only and other embodiments can be used without departing from the scope of the present disclosure.

In one embodiment, a UE can be provided with a set of configurations for LP-WUS, wherein the set of configurations include a time domain window for monitoring occasions (MOs) (or called reception or reception occasion (RO)) of LP-WUS.

For one further implementation, at least one of the examples can be configured by the higher layer parameters (e.g., such as based on an explicit indication which example to use, or an implicit way on whether a new timer is configured-if the new timer is configured, a first example is applied; and if the new timer is not configured, a second example is applied).

For one example, the time domain window for monitoring occasions of LP-WUS starts before a starting instance of a drx-onDurationTimer associated with a DRX cycle and/or ends before the starting instance of the drx-onDurationTimer.

With reference to FIG. 14, an example is shown.

For one instance, the time domain window for MOs does not overlap with the time period given by drx-onDuration Timer.

For another instance, the periodicity of the time domain window can be same as the periodicity of the DRX cycle.

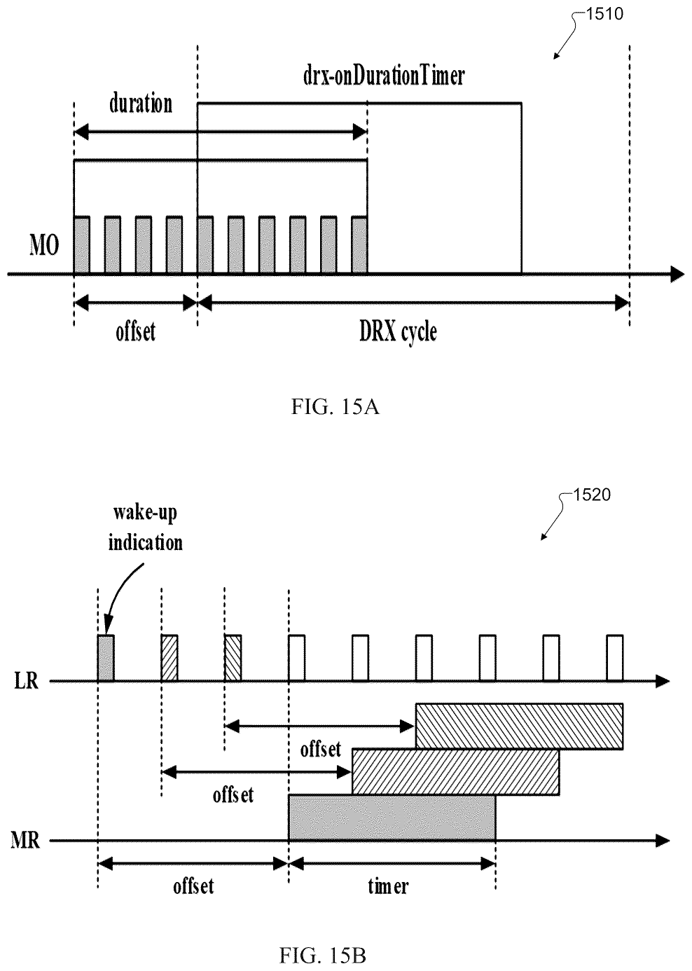

FIG. 15A illustrates a timeline 1510 of an example time domain window for MOs of LP-WUS according to embodiments of the present disclosure. For example, timeline 1510 can be followed by an of the UEs 111-116 of FIG. 1, such as the UE 112. This example is for illustration only and other embodiments can be used without departing from the scope of the present disclosure.

FIG. 15B illustrates a timeline 1520 of example LP-WUS monitoring according to embodiments of the present disclosure. For example, timeline 1520 can be followed by an of the UEs 111-116 of FIG. 1, such as the UE 113. This example is for illustration only and other embodiments can be used without departing from the scope of the present disclosure.

For yet another instance, the starting instance of the time domain window can be determined based on a time offset with respect to the starting instance of the time period given by drx-onDuration Timer.
For one sub-instance, the time offset can be configured by the gNB (e.g., the BS 102) in higher layer parameters.
For another sub-instance, the time offset can be determined based on a reported UE capability of a minimum delay requirement (e.g., the time offset minus the duration is not less than the reported minimum delay requirement).
For yet another sub-instance, the time offset can be determined based on UE assistance information.

For yet another instance, the time interval between two consecutive MOs within the time domain window can be configured by the gNB in higher layer parameters.
For one sub-instance, this time interval is applicable when the number of MOs in the time window is greater than 1.
For another sub-instance, the time interval is expected to be no less than the duration of a MO, e.g., when the interval is defined based on the starting time instance of two consecutive MOs.

For yet another instance, the time interval between two neighboring MOs within the time domain window can be fixed as 0 slot or 0 OFDM symbol.

For yet another instance, a number of MO(s) in the time domain window can be configured by the gNB in higher layer parameters.

For yet another instance, a number of MO(s) in the time domain window can be fixed as 1.

For yet another instance, a number of MO(s) in the time domain window can be determined based on a number of candidate values for a gap between MO and PDCCH monitoring occasions.

For yet another instance, a duration of the time domain window can be configured by the gNB in higher layer parameters. For this instance, the UE can determine a number of MOs in the time domain window based on the interval between neighboring MOs and the duration of the time domain window.

For yet another instance, the UE can select at least one MO to monitor within the time domain window (e.g., starting from the first MO within the time domain window), wherein the gap between the at least one MO and the start of the drx-onDurationTimer or the PDCCH monitoring occasion (e.g., first one located in the drx-onDurationTimer) is no less than the UE's minimum gap (e.g., as a UE capability).
For one further implementation, the UE may monitor such MOs satisfying the UE's minimum gap.
For another further implementation, the UE may assume the indications for the UE (e.g., on whether to wake up MR and/or monitor PDCCH for the UE) in MOs are the same.
For yet another further implementation, the UE may stop monitoring the remaining MOs in the time domain window after the reception of a wake-up indication for the UE in a MO in the time domain window.

For yet another instance, the UE can select one latest MO in the time domain to monitor within the time domain window, wherein the gap between the one MO and the start of the drx-onDurationTimer or the PDCCH monitoring occasion (e.g., first one located in the drx-onDurationTimer) is no less than the UE's minimum gap (e.g., as a UE capability).

For yet another instance, the UE may also select at least one MO to monitor within the time domain window (e.g., starting from the first MO within the time domain window), wherein the gap between the at least one MO and the start of the drx-onDurationTimer or the PDCCH monitoring occasion (e.g., first one located in the drx-onDurationTimer) is no less than the UE's preferred gap (e.g., indicated by UE assistant information).
For one further implementation, the UE (e.g., the UE 116) may monitor such MOs satisfying the UE's minimum gap (e.g., the gap between monitored MO within the time domain window and the start of the associated timer is no less than the UE's minimum gap).
For another further implementation, the UE may assume the indications for the UE (e.g., on whether to wake up MR and/or monitor PDCCH for the UE) in MOs are the same.
For yet another further implementation, the UE may stop monitoring the remaining MOs in the time domain window after the reception of a wake-up indication for the UE in a MO in the time domain window.

For another example, the time domain window for monitoring occasions of LP-WUS may be located anywhere within the DRX cycle (e.g., no restriction with the configuration of DRX cycle).

With reference to FIG. 15A, an example is shown.

For one instance, the time domain window for MOs may or may not overlap with the time period given by drx-onDurationTimer.

For another instance, the periodicity of the time domain window can be same as the periodicity of the DRX cycle.

For yet another instance, the periodicity of the time domain window can be same or smaller than the periodicity of the DRX cycle, e.g., the periodicity of the DRX cycle is an integer multiple of the periodicity of the time domain window.

For yet another instance, the periodicity of the time domain window can be configured by the gNB in higher layer parameters, e.g., without dependence with the DRX configuration.

For yet another instance, the starting instance of the time domain window can be determined based on a time offset with respect to the starting instance of the time period given by drx-onDurationTimer or a different timer from drx-onDurationTimer.
For one sub-instance, the time offset can be configured by the gNB in higher layer parameters.
For another sub-instance, the time offset can be determined based on a reported UE capability.
For yet another sub-instance, the time offset can be determined based on UE assistance information.
For yet another sub-instance, the time offset can be either positive or negative (or zero).

For yet another instance, the time interval between two neighboring MOs within the time domain window can be configured by the gNB in higher layer parameters, e.g., a subsequent MO within the time domain window occurs with the interval after its previous MO.
For one sub-instance, this time interval is applicable when the number of MOs in the time window is greater than 1.
For another sub-instance, the time interval is expected to be no less than the duration of a MO.

For yet another instance, the time interval between two neighboring MOs within the time domain window can be fixed as 0 slot or 0 OFDM symbol, e.g., a subsequent MO within the time domain window occurs immediately after its previous MO.

For yet another instance, a number of MO(s) in the time domain window can be configured by the gNB in higher layer parameters.

For yet another instance, a number of MO(s) in the time domain window can be fixed as 1.

For yet another instance, a number of MO(s) in the time domain window can be determined based on a number of candidate values for a gap between MO and PDCCH monitoring occasions.

For yet another instance, a duration of the time domain window can be configured by the gNB in higher layer parameters. For this instance, the UE can determine a number of MOs in the time domain window based on the interval between neighboring MOs and the duration of the time domain window.

For yet another instance, the UE can select at least one MO to monitor within the time domain window (e.g., starting from the first MO within the time domain window), wherein the gap between the at least one MO or the last MO within the time domain window and the start of the associated timer (e.g., the drx-onDurationTimer or new timer) or the PDCCH monitoring occasion (e.g., first one located in the drx-onDurationTimer or new timer) is no less than the UE's minimum gap (e.g., as a UE capability).
For one further implementation, the UE may monitor such MOs satisfying the UE's minimum gap, or the UE assumes MOs within the time domain window satisfies the UE's minimum gap (e.g., the gap between any MO within the time domain window and the start of the associated timer is no less than the UE's minimum gap).
For another further implementation, the UE may assume the indications for the UE (e.g., on whether to wake up MR and/or monitor PDCCH for the UE) in MOs are the same.
For yet another further implementation, this instance can be applicable when at least one MO is configured within the time domain window.
For yet another further implementation, the UE may stop monitoring the remaining MOs in the time domain window after the reception of a wake-up indication for the UE in a MO in the time domain window.

For yet another instance, the UE can select one latest MO in the time domain to monitor within the time domain window, wherein the gap between the one MO and PDCCH monitoring occasion (e.g., first one located in the drx-onDurationTimer or new timer) is no less than the UE's minimum gap (e.g., as a UE capability).
For one further implementation, this instance can be applicable when at least one MO is configured within the time domain window.

For yet another instance, the UE may also select at least one MO to monitor within the time domain window (e.g., starting from the first MO within the time domain window), wherein the gap between the at least one MO or the last MO within the window and the start of the drx-onDurationTimer or the PDCCH monitoring occasion (e.g., first one located in the drx-onDurationTimer or new timer) is no less than the UE's preferred gap (e.g., indicated by UE assistant information).
For one further implementation, the UE may monitor such MOs satisfying the UE's minimum gap.
For another further implementation, the UE may assume the indications for the UE (e.g., on whether to wake up MR and/or monitor PDCCH for the UE) in MOs are the same.
For yet another further implementation, this instance can be applicable when at least one MO is configured within the time domain window.
For yet another further implementation, the UE may stop monitoring the remaining MOs in the time domain window after the reception of a wake-up indication for the UE in a MO in the time domain window.

For yet another instance, the duration of time domain window can be configured same as the periodicity of the DRX cycle, which implies the LP-WUS MOs can be located anywhere in the DRX cycle (e.g., subject to the interval).

For yet another instance, when the duration of time domain window or a number of MOs is not configured, the UE determines the LP-WUS MOs can be located anywhere in the DRX cycle (e.g., subject to the interval).

For yet another instance (as shown in FIG. 15B), after a UE receives a LP-WUS indicating wake-up (e.g., to start the associated timer and monitor PDCCH) in a first MO, if the UE can determine at least one second MO located within the time offset between the first MO (or the last MO within the time domain window which includes the first MO, when multiple MOs are configured in the time domain window) and the beginning of the associated timer (e.g., when there are multiple MOs in the time domain window, the at least one second MO may not be in the same time domain window as the first MO), the UE can operate at least one of the following sub-instances (e.g., when multiple sub-instances are supported, the UE can be provided with a higher layer parameter to configure one sub-instance to perform):
In a first sub-instance, the UE does not need to monitor the at least one second MO.
   For one further implementation, the UE may assume the indication by the gNB in the at least one second MO is same as the first MO, if the indication includes information on whether to wake up for the UE.
   For another further implementation, this sub-instance can be applicable at least when the periodicity of the time domain window is less than (or no larger than) the duration of the new timer.
In a second sub-instance, the UE monitors the at least one second MO, and expects the indication in the at least one second MO is also a wake-up indication (e.g., the UE may assume the indication by the gNB in the at least one second MO is same as the first MO), e.g., if the information carried by the at least one second MO is also for the UE.
   For one further implementation, the UE determines the active time as the timer associated with the first MO (or the time domain window including the first MO).
   For another further implementation, the UE determines the active time as a union of timers associated with the first MO and the at least one second MO.
   For another further implementation, this sub-instance can be applicable at least when the periodicity of the time domain window is no less than (or larger than) the duration of the new timer.
   For another further implementation, this sub-instance can be applicable at least when the periodicity of the time domain window is less than (or no larger than) the duration of the new timer.
   For another further implementation, when the UE starts a new timer according to the first MO, and receives the wake-up indication based on the at least one second MO, the UE restarts the new timer according to the at least one second MO. For one further consideration, this can be applicable at least when the InactiveTimer is not started.
   For another further implementation, when the UE starts a new timer according to the first MO, and receives the wake-up indication based on the at least one second MO, the UE ignores the indication based on the at least one second MO. For one further consideration, this can be applicable at least when the InactiveTimer is started. For another further consideration, this can be applicable at least when the Inactive Timer is not started.
In a third sub-instance, the UE monitors the at least one second MO. The UE can expect the indication in the at least one second MO can be either same or different from the indication in the first MO, e.g., if the information carried by the at least one second MO is also for the UE.
   For one further implementation, the UE determines the active time as the timer associated with the first MO.
   For another further implementation, the UE determines the active time as a union of timers associated with the first MO and MO(s) in the at least one second MO which also indicate to wake-up.
   For yet another further implementation, the UE determines the active time as a first union of timers associated with the first MO and MO(s) in the at least one second MO which also indicate to wake-up, minus a second union of timers associated with the MO(s) in the at least one second MO which indicate not to wake-up.
   For yet another further implementation, the UE determines the active time as a timer associated with the last MO that indicates to wake-up.
   For yet another further implementation, a third MO in the at least one second MO can indicate not to wake-up, and cancel the indication of any indication of wake-up in the first MO or in any other forth MO before the third MO in the at least one second MO (e.g., the UE would not wake up according to the indication in the first MO and its associated timer). For one further implementation, if there is a fifth MO in the at least one second MO after the third MO, the UE can still wake up according to the fifth MO and its associated timer.
   For another further implementation, this sub-instance can be applicable at least when the periodicity of the time domain window is no less than (or larger than) the duration of the new timer.
   For another further implementation, this sub-instance can be applicable at least when the periodicity of the time domain window is less than (or no larger than) the duration of the new timer.
   For another further implementation, when the UE starts a new timer according to the first MO, and receives the wake-up indication based on the at least one second MO, the UE restarts the new timer according to the at least one second MO. For one further consideration, this can be applicable at least when the InactiveTimer is not started.
   For another further implementation, when the UE starts a new timer according to the first MO, and receives the wake-up indication based on the at least one second MO, the UE ignores the indication based on the at least one second MO. For one further consideration, this can be applicable at least when the InactiveTimer is started. For another further consideration, this can be applicable at least when the InactiveTimer is not started.

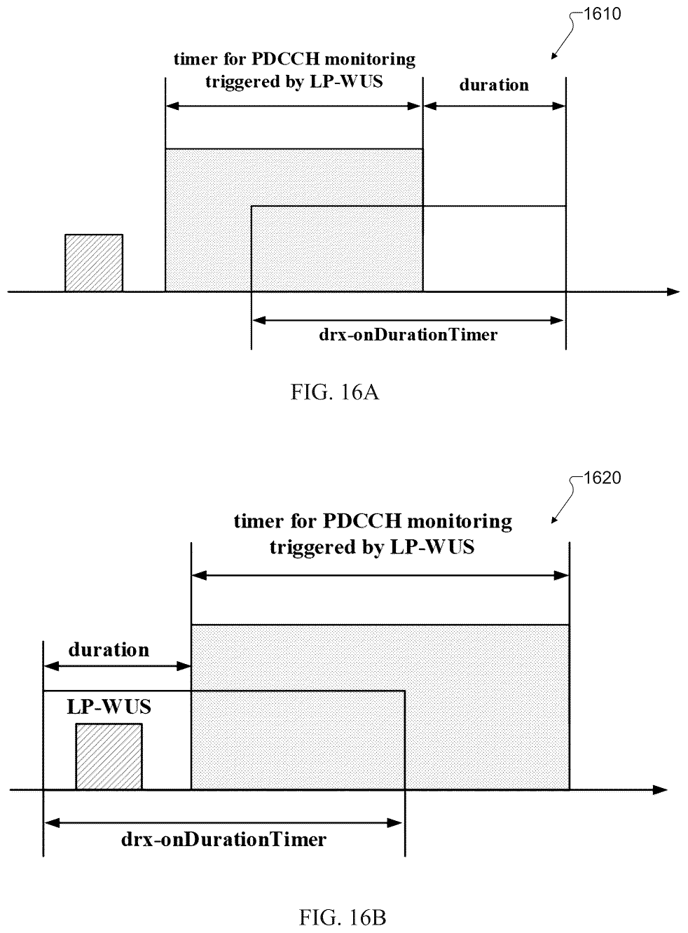

FIGS. 16A and 16B illustrate timelines 1610 and 1620 of an example duration for PDCCH monitoring according to embodiments of the present disclosure. For example, timelines 1610 and 1620 can be followed by an of the UEs 111-116 of FIG. 1, such as the UE 114. This example is for illustration only and other embodiments can be used without departing from the scope of the present disclosure.

In one embodiment, the CSI measurement and/or reporting, and/or L1-reference signal received power (RSRP) measurement and/or reporting can be impacted by LP-WUS.

For one example, when a timer for PDCCH monitoring is triggered by wake-up indication in LP-WUS (e.g., LP-WUS indicates wake-up, and the time period given by the timer is active time of the DRX operation) (e.g., LP-WUS(s) in at least one monitoring occasions in the periodicity for monitoring occasions), and the drx-onDurationTimer is not triggered (as described in example of this disclosure), there could a duration outside active time of the DRX operation (e.g., outside the timer for PDCCH monitoring triggered by wake-up indication in LP-WUS or outside the active time of the DRX operation) but within the time period given by drx-onDurationTimer (e.g., as illustrated in FIG. 16A or FIG. 16B). For this duration, a UE can be configured by higher layer parameter to determine whether to perform CSI measurement and/or reporting, and/or L1-RSRP measurement and/or reporting.
For one instance, this higher layer parameter can be same as the higher layer parameter for indicating whether to perform CSI measurement and/or reporting, and/or L1-RSRP measurement and/or reporting in the time period given by drx-onDurationTimer and also outside the active time of the DRX operation, wherein the wake-up indication in LP-WUS(s) (e.g., LP-WUS(s) in one or multiple or all of the monitoring occasions in the periodicity for monitoring occasions) indicates not-wake-up (or does not indicate wake-up).
For another instance, this higher layer parameter can be a separate higher layer parameter from the higher layer parameter for indicating whether to perform CSI measurement and/or reporting, and/or L1-RSRP measurement and/or reporting in the time period given by drx-onDuration Timer and also outside the active time of the DRX operation, wherein the wake-up indication in LP-WUS(s) (e.g., LP-WUS(s) in one or multiple or all of the monitoring occasions in the periodicity for monitoring occasions) indicates not-wake-up (or does not indicate wake-up).

For another example, when a timer for PDCCH monitoring is triggered by wake-up indication in LP-WUS (e.g., LP-WUS indicates wake-up, and the time period given by the timer is active time of the DRX operation) (e.g., LP-WUS(s) in at least one monitoring occasions in the periodicity for monitoring occasions), and the drx-onDurationTimer is not triggered (as described in example of this disclosure), there could a duration outside active time of the DRX operation (e.g., outside the timer for PDCCH monitoring triggered by wake-up indication in LP-WUS or outside the active time of the DRX operation) but within the time period given by drx-onDurationTimer (e.g., as illustrated in FIG. 16A or FIG. 16B). For this duration, a UE can determine to not to perform CSI measurement and/or reporting, and/or L1-RSRP measurement and/or reporting.

For yet another example, when a timer for PDCCH monitoring is triggered by wake-up indication in LP-WUS (e.g., LP-WUS indicates wake-up, and the time period given by the timer is active time of the DRX operation) (e.g., LP-WUS(s) in at least one monitoring occasions in the periodicity for monitoring occasions), and the drx-onDurationTimer is not triggered (as described in example of this disclosure), there could a duration outside active time of the DRX operation (e.g., outside the timer for PDCCH monitoring triggered by wake-up indication in LP-WUS or outside the active time of the DRX operation) but within the time period given by drx-onDurationTimer (e.g., as illustrated in FIG. 16A or FIG. 16B). For this duration, a UE can determine to perform CSI measurement and/or reporting, and/or L1-RSRP measurement and/or reporting.

For instance, if the UE is configured with DRX,
if the UE is configured to monitor LP-WUS and configured by a higher layer parameter to report CSI with the higher layer parameter reportConfigType set to ‘periodic’ and reportQuantity set to quantities other than ‘cri-RSRP’ and ‘ssb-Index-RSRP’ when drx-onDurationTimer in DRX-Config is not started, the most recent CSI measurement occasion occurs in DRX active time or during the time duration indicated by drx-onDuration Timer in DRX-Config also outside DRX active time for CSI to be reported;
   For one sub-instance, the higher layer parameter is a separate one from ps-TransmitOtherPeriodicCSI)
For another sub-instance, the higher layer parameter is ps-TransmitOtherPeriodicCSI
if the UE is configured to monitor LP-WUS and configured by a higher layer parameter to report L1-RSRP with the higher layer parameter reportConfigType set to ‘periodic’ and reportQuantity set to cri-RSRP when drx-onDurationTimer in DRX-Config is not started, the most recent CSI measurement occasion occurs in DRX active time or during the time duration indicated by drx-onDurationTimer in DRX-Config also outside DRX active time for CSI to be reported;
   For one sub-instance, the higher layer parameter is a separate one from ps-TransmitPeriodicL1-RSRP
   For another sub-instance, the higher layer parameter is ps-TransmitPeriodicL1-RSRP
otherwise, the most recent CSI measurement occasion occurs in DRX active time for CSI to be reported.

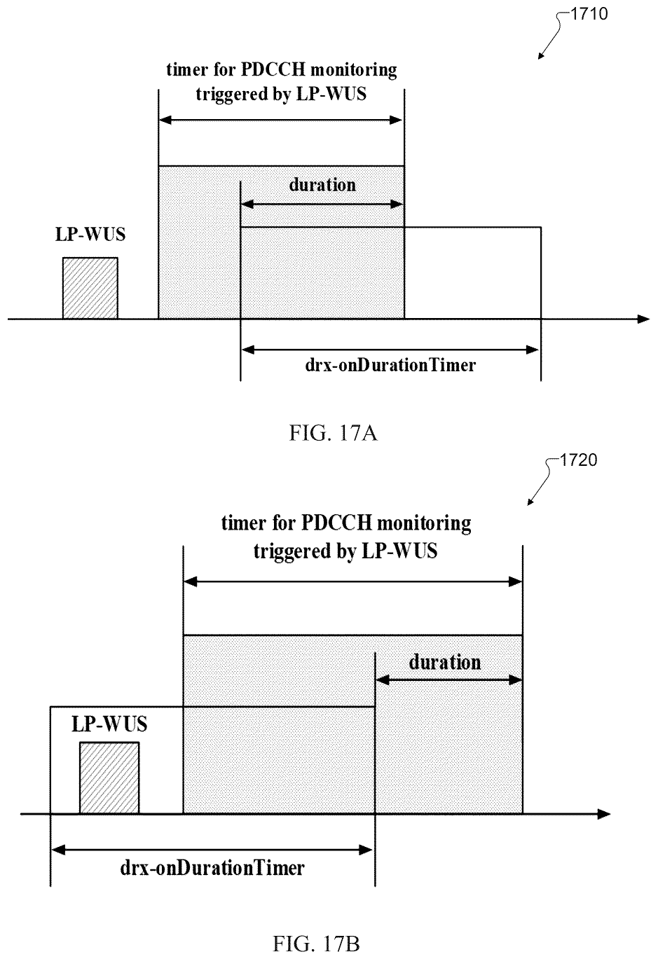

FIGS. 17A and 17B illustrate timelines 1710 and 1720 of an example duration for PDCCH monitoring according to embodiments of the present disclosure. For example, timelines 1710 and 1720 can be followed by an of the UEs 111-116 of FIG. 1, such as the UE 115. This example is for illustration only and other embodiments can be used without departing from the scope of the present disclosure.

For another example, when a timer for PDCCH monitoring is triggered by wake-up indication in LP-WUS, and the drx-onDurationTimer is not triggered (as described in example of this disclosure), there could a duration in the active time of the DRX operation (e.g., inside the timer for PDCCH monitoring triggered by wake-up indication in LP-WUS) and also within the time period given by drx-onDurationTimer (e.g., as illustrated in FIG. 17A or 17B). For this duration, a UE can be configured by higher layer parameter to determine whether to perform CSI measurement and/or reporting, and/or L1-RSRP measurement and/or reporting.

For yet another example, when a timer for PDCCH monitoring is triggered by wake-up indication in LP-WUS, and the drx-onDurationTimer is not triggered (as described in example of this disclosure), there could a duration in the active time of the DRX operation (e.g., inside the timer for PDCCH monitoring triggered by wake-up indication in LP-WUS) and also within the time period given by drx-onDurationTimer (e.g., as illustrated in FIG. 17A or 17B). For this duration, a UE can determine to perform CSI measurement and/or reporting, and/or L1-RSRP measurement and/or reporting.

NR supported discontinuous reception (DRX) for a UE in either RRC_IDLE/RRC_INACTIVE mode or RRC_CONNECTED mode, such that the UE could stop receiving signals or channels during the inactive period within the DRX cycle and save power consumption. In Rel-16, enhancement towards DRX for RRC_CONNECTED mode (e.g., C-DRX) was introduced, wherein a new DCI format was used to help the UE to skip a ON duration within a C-DRX cycle such that further power saving gain could be achieved. In Rel-17, enhancement towards DRX for RRC_IDLE/RRC_INACTIVE mode (e.g., I-DRX) was introduced, wherein a paging early indication (PEI) was used for a UE (e.g., the UE 116) to skip monitoring paging occasions such that extra power saving gain could be achieved.

However, the UE still needs to frequently wake up to monitor the new DCI format or the PEI, such that the radio of the UE cannot be fully turned off for a long duration. To avoid such situation and to acquire further power saving gain, an additional receiver radio is provided, wherein the additional receiver radio can be used for monitor a particular set of signals with very low power consumption, and the main receiver radio can be turned off or operating with a very lower power for a long duration. For one example, the low power signals can include a low power wake up signal (LP-WUS), e.g., a low power signal for waking up the main receiver and/or for PDCCH monitoring.

This disclosure focuses on the LP-WUS monitoring during active time of a DRX operation. For one further implementation, embodiments and examples of this disclosure can be applicable when DRX operation is configured for the serving cell, e.g., for RRC_CONNECTED mode.

This disclosure focuses on LP-WUS monitoring in active time for PDCCH monitoring.

More precisely, the following aspects are included in the disclosure:
General implementations for LP-WUS monitoring in active time
LP-WUS monitoring with PDCCH skipping
LP-WUS monitoring with search space group (SSG) switching
LP-WUS monitoring outside DRX ON duration

In one embodiment, a UE can determine a time duration as an active time when configured with discontinuous reception (DRX) operation, and the UE can further determine to monitor a low-power wake-up-signal (LP-WUS) (e.g., try to receive LP-WUS) for a time period within the active time according to at least one of the embodiments or examples in this disclosure.

For one further implementation, the active time can refer to the time duration wherein PDCCH is monitored by the UE, e.g., according to a set of monitoring occasions of the PDCCH. For one instance, the PDCCH can be at least one of a Type3-PDCCH which is monitored in a CSS set, or a PDCCH which is monitored in a USS set.

For another further implementation, the active time can refer to the time duration wherein at least one timer is running, e.g., the at least one timer can be provided by higher layer parameters.

For yet another further implementation, the UE may not be required to monitor LP-WUS other than the at least one of the embodiments or examples in this disclosure, e.g., as a default UE behavior, the UE may not be required to monitor LP-WUS in the active time (e.g., when monitoring PDCCH), or the UE may stop LP-WUS monitoring when the active time of the DRX operation starts.

For one further implementation, whether the UE monitors LP-WUS or not in the active time can be provided by a higher layer parameter.

For another further implementation, whether the UE monitors LP-WUS or not in the active time can be indicated by a DCI format.

For yet another further implementation, whether the UE monitors LP-WUS or not in the active time can be indicated by a MAC CE.

For yet another further implementation, whether the UE monitors LP-WUS or not in the active time can be a UE capability and reported to the BS.

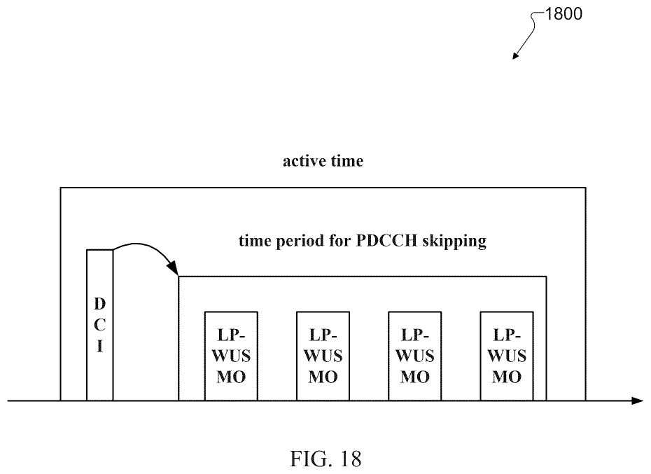

FIG. 18 illustrates a timeline 1800 of example LP-WUS monitoring according to embodiments of the present disclosure. For example, timeline 1800 can be followed by an of the UEs 111-116 of FIG. 1, such as the UE 116. This example is for illustration only and other embodiments can be used without departing from the scope of the present disclosure.

For one embodiment, a UE can monitor a LP-WUS based on LP-WUS reception occasions in a time period within the active time, when the UE determines to perform PDCCH skipping in the time period.

With reference to FIG. 18, an example embodiment is shown.

For one example, the UE can be indicated by a DCI format to perform PDCCH skipping. For one further implementation, the DCI format can be at least one of a DCI format 0_1, or a DCI format 1_1, or a DCI format 0_2, or a DCI format 1_2.

For another example, the UE can be provided a duration of the time period to perform PDCCH skipping. For one further implementation, the candidate values of the duration can be provided by RRC parameters, and the DCI format can indicate which candidate value is used for the PDCCH skipping.

For yet another example, the type of PDCCH that the UE can skip can be at least one of a Type3-PDCCH which is monitored in a CSS set, or a PDCCH which is monitored in a USS set

For yet another example, there could be cases wherein the UE may perform PDCCH skipping for a subset from the determined duration or may not perform PDCCH skipping (e.g., still monitor PDCCH), even if the DCI format indicates PDCCH skipping for the determined duration, and the first example of this disclosure is applicable for case(s) wherein PDCCH skipping is performed over the subset from the determined duration, and/or not applicable for case(s) wherein PDCCH skipping is not performed.
Case 1: If the UE transmits a physical uplink control channel (PUCCH) including a positive SR before the UE receives the DCI format indicating the UE to skip PDCCH monitoring and the SR is pending, the UE may not perform PDCCH skipping (e.g., still monitoring PDCCH) regardless of the indication in the DCI format.
Case 2: If the UE transmits a PUCCH including a positive SR after the UE receives the DCI format indicating the UE to skip PDCCH monitoring, the UE performs PDCCH skipping before the first slot after the PUCCH transmission, and/or begins to monitor PDCCH from the first slot after the PUCCH transmission.
Case 3: If the random access contention resolution timer is running, or during the response window for msg1 or msgA, the UE may not perform PDCCH skipping (e.g., still monitoring PDCCH) regardless of the indication in the DCI format.
Case 4: If the UE receives the DCI format indicating the UE to skip PDCCH monitoring, the UE performs PDCCH skipping before the contention resolution is successful, and/or the UE begins to monitor PDCCH when the contention resolution is successful.
Case 5: If the UE receives the DCI format indicating the UE to skip PDCCH monitoring, the UE performs PDCCH skipping before a SR is cancelled, and/or the UE begins to monitor PDCCH when a SR is cancelled.
Case 6: If the UE transmits a physical random access channel (PRACH) due to positive SR, and if the random access contention resolution timer is running, or during the response window for msg1 or msgA, the UE may not perform PDCCH skipping (e.g., still monitoring PDCCH) regardless of the indication in the DCI format.
Case 7: If DRX is configured and the UE receives the DCI format indicating the UE to skip PDCCH monitoring in active time of the DRX operation, the UE performs PDCCH skipping before the end of the active time, and/or the UE terminates PDCCH skipping after the end of active time.

For yet another example, a first minimum time domain delay can be applied after the UE receives the DCI format indicating the UE to skip PDCCH monitoring, before performing PDCCH skipping.

For yet another example, a second minimum time domain delay can be applied after the UE performs PDCCH skipping, and before performing LP-WUS monitoring. For one further implementation, the LP-WUS monitoring occasion that the UE starts to monitor is at least with the second minimum time domain delay comparing to the instance that the UE starts to perform PDCCH skipping.

For yet another example, a third minimum time domain delay can be applied after the UE receives the DCI format indicating the UE to skip PDCCH monitoring, before performing LP-WUS monitoring. For one further implementation, the third minimum time domain delay can include two parts: a first part for the minimum time domain delay between receiving the DCI format indicating the UE to skip PDCCH monitoring and performing PDCCH skipping; and a second part for the minimum time domain delay between starting to perform PDCCH skipping and before starting to perform LP-WUS monitoring. For another further implementation, the LP-WUS monitoring occasion that the UE starts to monitor is at least with the third minimum time domain delay comparing to the instance that the UE receives the DCI format (e.g., end of the symbol(s) or slot including the DCI format). For yet another further implementation, the UE can be provided, by higher layer parameter, a delay from receiving the DCI format indicating the UE to skip PDCCH monitoring to the slot (or first slot in the slot(s)) including the first MO for LP-WUS that the UE starts to monitor, wherein the delay is no less than the third minimum time domain delay.

For yet another example, the UE monitors LP-WUS continuously within the time period (e.g., subject to a minimum time domain delay as in the examples of this disclosure).

For yet another example, the UE can monitor LP-WUS within the time period subject to a configuration of the LP-WUS monitoring occasion(s), wherein the configuration is same as the configuration when LP-WUS monitoring occasion(s) are outside the active time.

For yet another example, the UE can monitor LP-WUS within the time period subject to a configuration of the LP-WUS monitoring occasion(s), wherein the configuration is a dedicated one and separate from the configuration when LP-WUS monitoring occasion(s) are outside the active time. For instance, the configuration on the periodicity of the monitoring occasion(s) can be different.

For yet another example, the UE can monitor LP-WUS within the time period subject to a set of LP-WUS monitoring occasion(s), wherein the LP-WUS monitoring occasion(s) can be determined by the UE with fixed relationship to PDCCH monitoring occasions in the time period and the PDCCH are not from Type3-PDCCH CSS set or USS set.

For yet another example, the UE can assume the resources for LP-WUS monitoring occasion(s) do not overlap with resources for PDCCH not from Type3-PDCCH CSS set or USS set in the time period. For one instance, the resources can be time domain resources. For another instance, the resource can be frequency domain resources. For yet another instance, the resources can be both time domain resources and frequency domain resources.

For yet another example, if the resources for LP-WUS monitoring occasion(s) do not overlap with resources for PDCCH not from Type3-PDCCH CSS set or USS set, in time and/or frequency domain, the UE can skip monitor LP-WUS in the corresponding monitoring occasion(s).

For yet another example, if the UE didn't identify any monitoring occasion within the time period, the UE may not monitor LP-WUS within the time period.

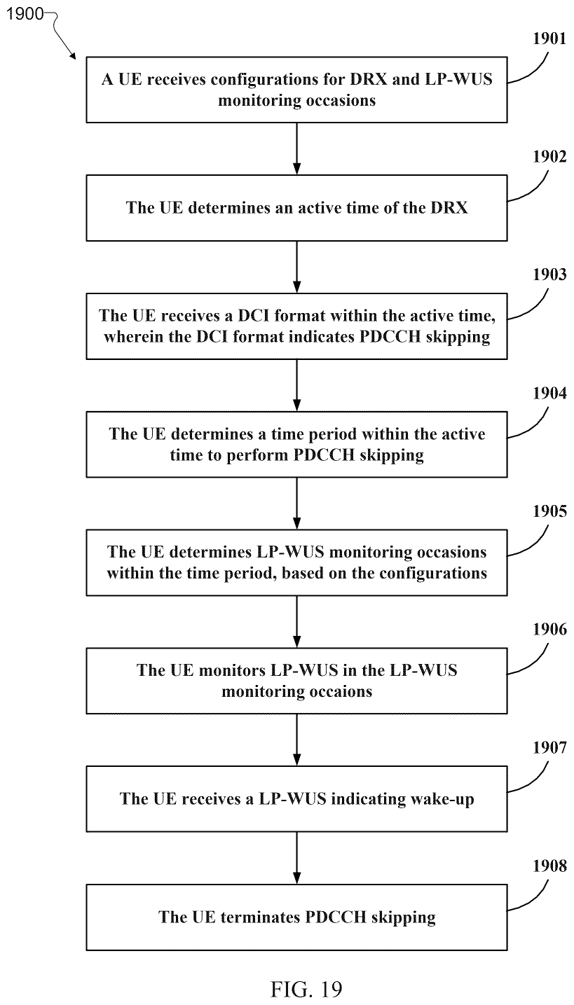

FIG. 19 illustrates a flowchart of an example UE procedure 1900 for LP-WUS monitoring according to embodiments of the present disclosure. For example, procedure 1900 can be performed by the UE 116 of FIG. 3. This example is for illustration only and other embodiments can be used without departing from the scope of the present disclosure.

The procedure begins in 1901, a UE receives configurations for DRX and LP-WUS monitoring occasions. In 1902, the UE determines an active time of the DRX. In 1903, the UE receives a DCI format within the active time, wherein the DCI format indicates PDCCH skipping. In 1904, the UE determines a time period within the active time to perform PDCCH skipping. In 1905, the UE determines LP-WUS monitoring occasions within the time period, based on the configurations. In 1906, the UE monitors LP-WUS in the LP-WUS monitoring occasions. In 1907, the UE receives a LP-WUS indicating wake-up. In 1908, the UE terminates PDCCH skipping.

For yet another example, if the UE receives a LP-WUS indicating wake-up within the time period when performing PDCCH skipping, the UE terminates the PDCCH skipping

For yet another example, if the UE receives a LP-WUS indicating wake-up within the time period when performing PDCCH skipping, the UE terminates the LP-WUS monitoring.

For yet another example, if the UE receives a LP-WUS indicating wake-up within the time period when performing PDCCH skipping, the UE starts or resets a timer and resumes to monitor PDCCH when the timer is running.

For yet another example, if the UE receives a LP-WUS indicating wake-up within the time period when performing PDCCH skipping, the UE resumes to monitor PDCCH, e.g., for the remaining of the time period for PDCCH skipping.

For yet another example, whether the UE monitors LP-WUS or not in the time period when performing PDCCH skipping can be provided by a higher layer parameter.

For yet another example, whether the UE monitors LP-WUS or not in the time period when performing PDCCH skipping can be indicated by the DCI format.

For yet another example, whether the UE monitors LP-WUS or not in the time period when performing PDCCH skipping can be indicated by a MAC CE.

For yet another example, whether the UE monitors LP-WUS or not in the time period when performing PDCCH skipping can be a UE capability and reported to the BS.

With reference to FIG. 19, An example UE procedure for monitoring LP-WUS in the time period when performing PDCCH skipping is shown.

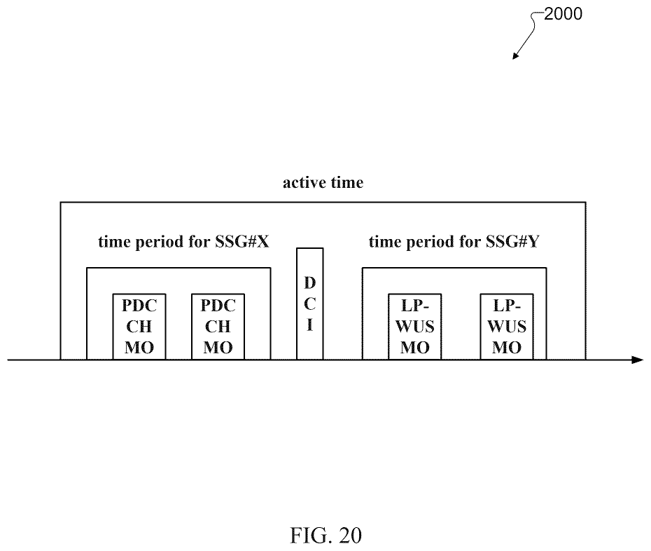

FIG. 20 illustrates a timeline 2000 of example LP-WUS monitoring according to embodiments of the present disclosure. For example, timeline 2000 can be followed by an of the UEs 111-116 of FIG. 1, such as the UE 111. This example is for illustration only and other embodiments can be used without departing from the scope of the present disclosure.

For one embodiment, a UE can monitor a LP-WUS based on LP-WUS reception occasions in a time period within the active time, when the UE monitors PDCCH according to a search space set with respect to a particular SSG in the time period (e.g., after SSG switching indicated by a DCI format), wherein the particular SSG can be further subject to at least one example of this embodiment.

With reference to FIG. 20, an example embodiment is shown.

For one example, the UE can be indicated by a DCI format to perform SSG switching. For one further implementation, the DCI format can be at least one of a DCI format 0_1, or a DCI format 1_1, or a DCI format 0_2, or a DCI format 1_2. For another further implementation, the DCI format can be a DCI format 2_0.

For another example, the UE can be provided a duration of the time period to monitor PDCCH according to the particular SSG. For instance, the duration can be provided by higher layer parameters.

For yet another example, the type of PDCCH associated with a SSG can be at least one of a Type3-PDCCH which is monitored in a CSS set, or a PDCCH which is monitored in a USS set

For yet another example, the particular SSG may not include any Type3-PDCCH CSS set or any USS set. For instance, the UE may not need to monitor PDCCH with Type3-PDCCH CSS set or USS set in the time period associated with the particular SSG.

For yet another example, the particular SSG can be the default SSG that other SSG(s) falls back to after a timer expires, e.g., SSG #0.

For yet another example, the particular SSG can be the a SSG associated with an explicit timer, e.g., SSG #1 or SSG #2.

For yet another example, a first minimum time domain delay can be applied after the UE receives the DCI format indicating the SSG switching, before monitoring the PDCCH according to the particular SSG.

For yet another example, a second minimum time domain delay can be applied after the UE starts to monitor the PDCCH according to the particular SSG, and before performing LP-WUS monitoring. For one further implementation, the LP-WUS monitoring occasion that the UE starts to monitor is at least with the second minimum time domain delay comparing to the instance that the UE starts to monitor the PDCCH according to the particular SSG.

For yet another example, a third minimum time domain delay can be applied after the UE receives the DCI format indicating the SSG switching, before performing LP-WUS monitoring. For one further implementation, the third minimum time domain delay can include two parts: a first part for the minimum time domain delay between receiving the DCI format indicating the SSG switching and starting to monitor the PDCCH according to the particular SSG; and a second part for the minimum time domain delay between starting to monitor the PDCCH according to the particular SSG and before starting to perform LP-WUS monitoring. For another further implementation, the LP-WUS monitoring occasion that the UE starts to monitor is at least with the third minimum time domain delay comparing to the instance that the UE receives the DCI format indicating the SSG switching (e.g., end of the symbol(s) or slot including the DCI format). For yet another further implementation, the UE can be provided, by higher layer parameter, a delay from receiving the DCI format indicating the SSG switching to the slot (or first slot in the slot(s)) including the first MO for LP-WUS that the UE starts to monitor, wherein the delay is no less than the third minimum time domain delay.

For yet another example, the UE monitors LP-WUS continuously within the time period (e.g., subject to a minimum time domain delay as in the examples of this disclosure).

For yet another example, the UE can monitor LP-WUS within the time period subject to a configuration of the LP-WUS monitoring occasion(s), wherein the configuration is same as the configuration when LP-WUS monitoring occasion(s) are outside the active time.

For yet another example, the UE can monitor LP-WUS within the time period subject to a configuration of the LP-WUS monitoring occasion(s), wherein the configuration is a dedicated one and separate from the configuration when LP-WUS monitoring occasion(s) are outside the active time. For instance, the configuration on the periodicity of the monitoring occasion(s) can be different.

For yet another example, the UE can monitor LP-WUS within the time period subject to a set of LP-WUS monitoring occasion(s), wherein the LP-WUS monitoring occasion(s) can be determined by the UE with fixed relationship to PDCCH monitoring occasions in the time period and the PDCCH are not from Type3-PDCCH CSS set or USS set.

For yet another example, the UE can assume the resources for LP-WUS monitoring occasion(s) do not overlap with resources for PDCCH not from Type3-PDCCH CSS set or USS set in the time period. For one instance, the resources can be time domain resources. For another instance, the resource can be frequency domain resources. For yet another instance, the resources can be both time domain resources and frequency domain resources.

For yet another example, if the resources for LP-WUS monitoring occasion(s) do not overlap with resources for PDCCH not from Type3-PDCCH CSS set or USS set, in time and/or frequency domain, the UE can skip monitor LP-WUS in the corresponding monitoring occasion(s).

For yet another example, if the UE (e.g., the UE 116) didn't identify any monitoring occasion within the time period, the UE may not monitor LP-WUS within the time period.

For yet another example, if the UE receives a LP-WUS indicating wake-up within the time period when monitoring the PDCCH according to the particular SSG, the UE terminates monitoring the PDCCH according to the particular SSG (e.g., terminates the timer for monitoring PDCCH according to the particular SSG).
For one instance, the UE starts to monitor PDCCH according to the default SSG (e.g., SSG #0).
For another instance, the UE starts to monitor PDCCH according to a SSG indicated by the LP-WUS.
For yet another instance, the UE starts to monitor PDCCH according to a SSG with a Type3-PDCCH CSS set or a USS set. For one further implementation, if there are multiple SSGs with a Type3-PDCCH CSS set or a USS set, the UE can monitor PDCCH according to the SSG with the smallest index.

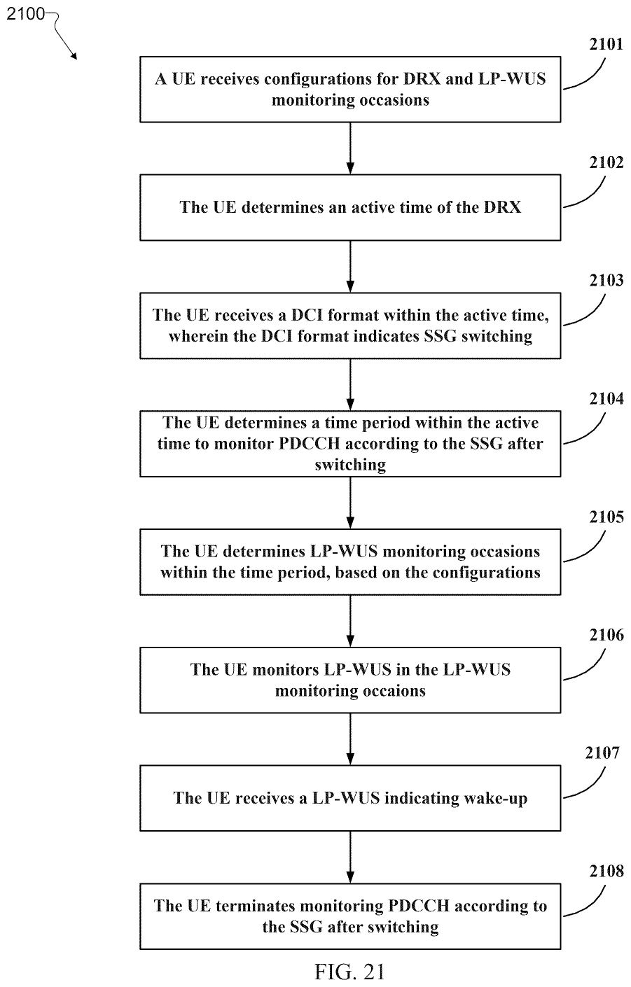

FIG. 21 illustrates a flowchart of an example UE procedure 2100 for LP-WUS monitoring according to embodiments of the present disclosure. For example, procedure 2100 can be performed by the UE 116 of FIG. 3. This example is for illustration only and other embodiments can be used without departing from the scope of the present disclosure.

The procedure begins in 2101, a UE receives configurations for DRX and LP-WUS monitoring occasions. In 2102, the UE determines an active time of the DRX. In 2103, the UE receives a DCI format within the active time, wherein the DCI format indicates SSG switching. In 2104, the UE determines a time period within the active time to monitor PDCCH according to the SSG after switching. In 2105, the UE determines LP-WUS monitoring occasions within the time period, based on the configurations. In 2106, the UE monitors LP-WUS in the LP-WUS monitoring occasions. In 2107, the UE receives a LP-WUS indicating wake-up. In 2108, the UE terminates monitoring PDCCH according to the SSG after switching.

For yet another example, if the UE receives a LP-WUS indicating wake-up within the time period when monitoring the PDCCH according to the particular SSG, the UE terminates the LP-WUS monitoring.

For yet another example, if the UE receives a LP-WUS indicating wake-up within the time period when monitoring the PDCCH according to the particular SSG, the UE starts or resets a timer and resumes to monitor PDCCH when the timer is running.

For yet another example, whether the UE monitors LP-WUS or not in the time period when monitoring the PDCCH according to the particular SSG can be provided by a higher layer parameter.

For yet another example, whether the UE monitors LP-WUS or not in the time period when monitoring the PDCCH according to the particular SSG can be indicated by the DCI format.

For yet another example, whether the UE monitors LP-WUS or not in the time period when monitoring the PDCCH according to the particular SSG can be indicated by a MAC CE.

For yet another example, whether the UE monitors LP-WUS or not in the time period when monitoring the PDCCH according to the particular SSG can be a UE capability and reported to the BS.

With reference to FIG. 21, an example UE procedure for monitoring LP-WUS in the time period when monitoring the PDCCH according to the particular SSG is shown.

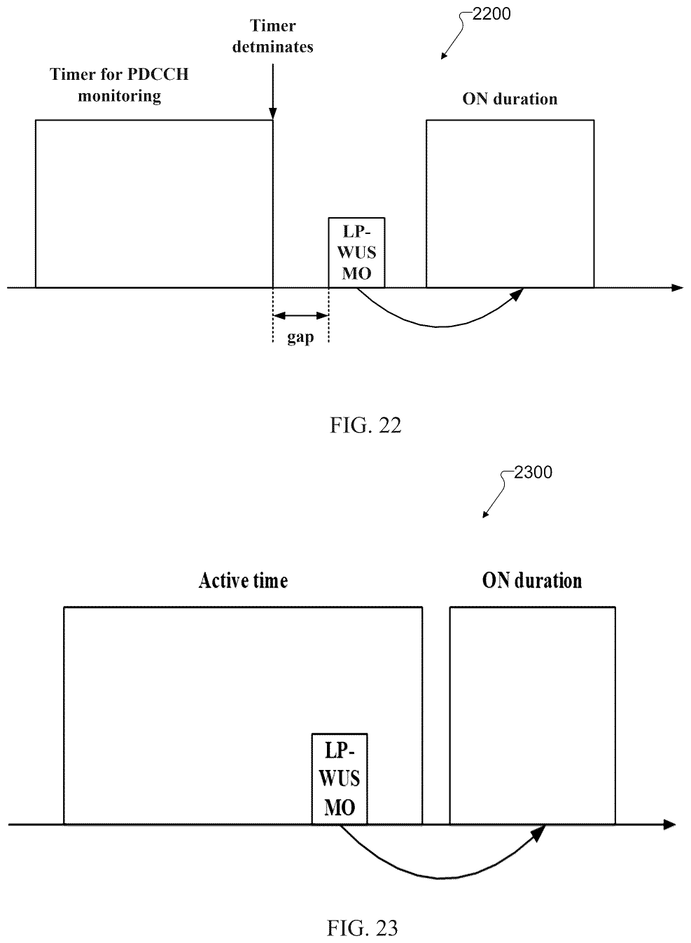

FIG. 22 illustrates a timeline 2200 for terminating an example timer for PDCCH monitoring according to embodiments of the present disclosure. For example, timeline 2200 can be followed by an of the UEs 111-116 of FIG. 1, such as the UE 112. This example is for illustration only and other embodiments can be used without departing from the scope of the present disclosure.

For one embodiment, when a timer (e.g., Inactivity timer, or Retransmission timer, or round-trip time (RTT) timer) for PDCCH monitoring is running, and at least one LP-WUS monitoring occasion is located before the end of the timer, then the UE terminates the timer before the at least one LP-WUS monitoring occasion and start to monitor LP-WUS in the at least one LP-WUS monitoring occasion.

For one further implementation, the embodiment can be applicable with a further implementation that the at least one LP-WUS monitoring occasion is intended for the LP-WUS to trigger the PDCCH monitoring from the beginning of the next ON duration (e.g., determined by drx-OnDuration Timer).

For another further implementation, there can be a time gap between the termination of the timer and the start of the at least one LP-WUS monitoring occasion. For one instance, the time gap can be fixed as 0 (i.e., no gap). For another instance, the time gap can be equal to or no less than a minimum delay (e.g., used for preparation of LP-WUS monitoring).

With reference to FIG. 22, an example embodiment is shown.

FIG. 23 illustrates a timeline 2300 for LP-WUS monitoring according to embodiments of the present disclosure. For example, timeline 2300 can be followed by an of the UEs 111-116 of FIG. 1, such as the UE 113. This example is for illustration only and other embodiments can be used without departing from the scope of the present disclosure.

For another embodiment, at least one LP-WUS monitoring occasion can be located within an active time (e.g., for PDCCH monitoring) with the DRX operation, and the UE monitors the LP-WUS in the at least one LP-WUS monitoring occasion when at least one of the following examples is applicable.

For one example, the LP-WUS to be monitored in the LP-WUS monitoring occasion is intended for triggering PDCCH monitoring within a timer wherein the start of the timer is not within the active time. For instance, it can be intended for triggering the PDCCH monitoring from the beginning of the next ON duration (e.g., determined by drx-OnDuration Timer).

For another example, the location of the LP-WUS monitoring occasion is at least with a minimum delay requirement after monitoring or receiving a DL transmission (e.g., PDCCH and/or PDSCH) within the active time.

For yet another example, the location of the LP-WUS monitoring occasion is outside the ON duration of a DRX cycle (e.g., determined by drx-OnDuration Timer).

For yet another example, the resources for LP-WUS monitoring occasion(s) do not overlap with resources for PDCCH in the active time, in in time and/or frequency domain.

With reference to FIG. 23, an example embodiment is shown.

For yet another embodiment, at least one LP-WUS monitoring occasion can be located within an active time (e.g., for PDCCH monitoring) with the DRX operation, and the UE may not monitor the LP-WUS in the at least one LP-WUS monitoring occasion when at least one of the following examples is applicable.

For one example, the LP-WUS to be monitored in the LP-WUS monitoring occasion is intended for triggering PDCCH monitoring within a timer wherein the start of the timer is within the active time. For instance, it can be intended for triggering the PDCCH monitoring from a time instance before or after the beginning of the next ON duration (e.g., determined by drx-OnDuration Timer).

For another example, the location of the LP-WUS monitoring occasion is not with a minimum delay requirement after monitoring or receiving a DL transmission (e.g., PDCCH and/or PDSCH) within the active time.

For yet another example, the location of the LP-WUS monitoring occasion is outside the ON duration of a DRX cycle (e.g., determined by drx-OnDurationTimer).

For yet another example, the location of the LP-WUS monitoring occasion is inside the ON duration of a DRX cycle (e.g., determined by drx-OnDurationTimer).

For yet another example, the resources for LP-WUS monitoring occasion(s) overlap with resources for PDCCH in the active time, in in time and/or frequency domain.

For one embodiment, when a UE is configured with cell DTX operation (e.g., the cell DTX operation is also activated), the UE can determine a time period to perform LP-WUS monitoring.

For one example, the time period can correspond to an active time of a DRX operation and a non-active time of the cell DTX operation.

For another example, the time period can correspond to a non-active time of a DRX operation and/or an active time of the cell DTX operation.

For yet another example, the UE may not monitor PDCCH during the time period. For one instance, the PDCCH can be at least one of a Type3-PDCCH which is monitored in a CSS set, or a PDCCH which is monitored in a USS set. For another instance, the UE may not monitor PDCCH in the time period if the following conditions are not satisfied:
if any drx-Retransmission TimerDL, drx-RetransmissionTimerUL or drx-RetransmissionTimerSL is running on any Serving Cell in the DRX group of this Serving Cell; or
if ra-ContentionResolutionTimer or msgB-ResponseWindow is running; or
if a Scheduling Request is sent on PUCCH and is pending; or
if a PDCCH indicating a new transmission addressed to the cell-radio network temporary identifier (C-RNTI) of the MAC entity has not been received after successful reception of a Random Access Response for the Random Access Preamble not selected by the MAC entity among the contention-based Random Access Preamble, or
if ra-ResponseWindow is running and this Serving Cell is the SpCell.

For another example, the UE monitors LP-WUS continuously within the time period (e.g., subject to a minimum time domain delay as in the examples of this disclosure).

For yet another example, the UE can monitor LP-WUS within the time period subject to a configuration of the LP-WUS monitoring occasion(s), wherein the configuration is same as the configuration when LP-WUS monitoring occasion(s) are outside the active time.

For yet another example, the UE can monitor LP-WUS within the time period subject to a configuration of the LP-WUS monitoring occasion(s), wherein the configuration is a dedicated one and separate from the configuration when LP-WUS monitoring occasion(s) are outside the active time. For instance, the configuration on the periodicity of the monitoring occasion(s) can be different.

For yet another example, the UE can monitor LP-WUS within the time period subject to a set of LP-WUS monitoring occasion(s), wherein the LP-WUS monitoring occasion(s) can be determined by the UE with fixed relationship to PDCCH monitoring occasions in the time period and the PDCCH are not from Type3-PDCCH CSS set or USS set.

For yet another example, the UE can assume the resources for LP-WUS monitoring occasion(s) do not overlap with resources for PDCCH not from Type3-PDCCH CSS set or USS set in the time period. For one instance, the resources can be time domain resources. For another instance, the resource can be frequency domain resources. For yet another instance, the resources can be both time domain resources and frequency domain resources.

For yet another example, if the resources for LP-WUS monitoring occasion(s) do not overlap with resources for PDCCH not from Type3-PDCCH CSS set or USS set, in time and/or frequency domain, the UE can skip monitor LP-WUS in the corresponding monitoring occasion(s).

For yet another example, if the UE didn't identify any monitoring occasion within the time period, the UE may not monitor LP-WUS within the time period.

For yet another example, if the UE receives a LP-WUS indicating wake-up within the time period, the UE starts to monitor PDCCH and/or starts/restarts a timer.

For yet another example, if the UE receives a LP-WUS indicating wake-up within the time period, the UE terminates the LP-WUS monitoring.

For yet another example, whether the UE monitors LP-WUS or not in the time period can be provided by a higher layer parameter.

For yet another example, whether the UE monitors LP-WUS or not in the time period can be indicated by the DCI format.

For yet another example, whether the UE monitors LP-WUS or not in the time period can be indicated by a MAC CE.

For yet another example, whether the UE monitors LP-WUS or not in the time period can be a UE capability and reported to the BS.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A base station (BS) in a wireless communication system, the BS comprising:
a processor configured to:
determine, based on a set of higher layer parameters, a periodicity, a first time offset, a timer, and a number of wake-up-signal (WUS) monitoring occasions (MOs); and
determine a time domain window to transmit a WUS, wherein the time domain window periodically occurs with the periodicity and includes the number of WUS MOs; and
a transceiver operably coupled to the processor, the transceiver configured to:
transmit the set of higher layer parameters; and
transmit the WUS based on the number of WUS MOs,
wherein the processor is further configured to:
determine a time instance to start the timer based on the first time offset, and
determine to transmit a physical downlink control channel (PDCCH) when the timer is running.

2. The BS of claim 1, wherein the time instance to start the timer is offset from a start of a first WUS MO within the number of WUS MOs by the first time offset.

3. The BS of claim 1, wherein:
the transceiver is further configured to receive a time domain gap as a user equipment (UE) capability,
the processor is further configured to determine a second time offset from a last WUS MO within the number of WUS MOs to the time instance, and
the second time offset is no smaller than the time domain gap.

4. The BS of claim 1, wherein the processor is further configured to:
determine an active time interval for monitoring the PDCCH when the timer is running; and
determine not to transmit the WUS during the active time interval.

5. The BS of claim 1, wherein the processor is further configured to:
determine, based on the set of higher layer parameters, an activation of a cell discontinuous transmission (DTX) operation and a non-active time of the cell DTX operation; and
determine not to transmit the WUS during the non-active time.

6. The BS of claim 1, wherein the processor is further configured to:
determine an indication of a unified transmission configuration indication (TCI) framework based on the set of higher layer parameters; and
determine to transmit the WUS based on (i) a first TCI state indicated by a most recent downlink control information (DCI) after a first application time or (ii) a second TCI state indicated by a most recent medium access control (MAC) control element (CE) after a second application time.

7. The BS of claim 1, wherein the processor is further configured to:
determine, based on the set of higher layer parameters, an indication of a non-unified transmission configuration indication (TCI) framework and an indication of quasi-co-location (QCL) information; and
determine to transmit the WUS based on the QCL information.

8. A user equipment (UE) in a wireless communication system, the UE comprising:
a transceiver configured to receive a set of higher layer parameters; and
a processor operably coupled to the transceiver, the processor configured to:
determine, based on the set of higher layer parameters, a periodicity, a first time offset, a timer, and a number of wake-up-signal (WUS) monitoring occasions (MOs); and
determine a time domain window for monitoring the WUS, wherein the time domain window periodically occurs with the periodicity and includes the number of WUS MOs,
wherein the transceiver is further configured to receive a WUS based on the number of WUS MO, and
wherein the processor is further configured to:
determine a time instance to start the timer based on the first time offset, and
determine to monitor a physical downlink control channel (PDCCH) when the timer is running.

9. The UE of claim 8, wherein the time instance to start the timer is offset from a start of a first WUS MO within the number of WUS MOs by the first time offset.

10. The UE of claim 8, wherein:
the transceiver is further configured to report a time domain gap as a UE capability,
the processor is further configured to determine a second time offset from a last WUS MO within the number of WUS MOs to the time instance, and
the second time offset is no smaller than the time domain gap.

11. The UE of claim 8, wherein the processor is further configured to:
determine an active time interval for monitoring the PDCCH when the timer is running; and
determine not to monitor the WUS during the active time interval.

12. The UE of claim 8, wherein the processor is further configured to:
determine, based on the set of higher layer parameters, an activation of a cell discontinuous transmission (DTX) operation and a non-active time of the cell DTX operation; and
determine not to monitor the WUS during the non-active time.

13. The UE of claim 8, wherein the processor is further configured to:
determine, based on the higher layer parameters, an indication of a unified transmission configuration indication (TCI) framework; and
determine to monitor the WUS based on (i) a first TCI state indicated by a most recent downlink control information (DCI) after a first application time or (ii) based on a second TCI state indicated by a most recent medium access control (MAC) control element (CE) after a second application time.

14. The UE of claim 8, wherein the processor is further configured to:
determine, based on the higher layer parameters, an indication of a non-unified transmission configuration indication (TCI) framework; and
determine to monitor the WUS based on quasi-co-location (QCL) information configured by the set of higher layer parameters.

15. A method of a user equipment (UE) in a wireless communication system, the method comprising:
receiving a set of higher layer parameters;
determining, based on the set of higher layer parameters, a periodicity, a first time offset, a timer, and a number of wake-up-signal (WUS) monitoring occasions (MOs);
determining a time domain window for monitoring the WUS, wherein the time domain window periodically occurs with the periodicity and includes the number of WUS MOs;
receiving a WUS based on the number of WUS MOs;
determining a time instance to start the timer based on the first time offset; and
determining to monitor a physical downlink control channel (PDCCH) when the timer is running.

16. The method of claim 15, wherein the time instance to start the timer offset from a start of a first WUS MO within the number of WUS MOs by the first time offset.

17. The method of claim 15, further comprising:
reporting a time domain gap as a UE capability;
determining a second time offset from a last WUS MO within the number of WUS MOs to the time instance, wherein the second time offset is no smaller than the time domain gap;
determining an active time for monitoring the PDCCH when the timer is running; and
determining not to monitor the WUS during the active time.

18. The method of claim 15, further comprising:
determining, based on the set of higher layer parameters, an activation of a cell discontinuous transmission (DTX) operation and a non-active time of the cell DTX operation; and
determining not to monitor the WUS during the non-active time.

19. The method of claim 15, further comprising:
determining, based on the higher layer parameters, an indication of a unified transmission configuration indication (TCI) framework; and
determining to monitor the WUS based on (i) a first TCI state indicated by a most recent downlink control information (DCI) after a first application time or (ii) based on a second TCI state indicated by a most recent medium access control (MAC) control element (CE) after a second application time.

20. The method of claim 15, further comprising:
determining, based on the higher layer parameters, an indication of a non-unified transmission configuration indication (TCI) framework; and
determining to monitor the WUS based on quasi-co-location (QCL) information configured by the set of higher layer parameters.
